(19) United States
(12) Patent Application Publication
(10) Pub. No.: US 2026/0120527 A1
(43) Pub. Date: Apr. 30, 2026

(54) SHIPPING READINESS VERIFICATION

(71) Applicant: Oshkosh Corporation, Oshkosh, WI (US)

(72) Inventor: Prabhu Shankar, Oshkosh, WI (US)

(73) Assignee: Oshkosh Corporation, Oshkosh, WI (US)

(21) Appl. No.: 19/087,298

(22) Filed: Mar. 21, 2025

Related U.S. Application Data
(60) Provisional application No. 63/712,618, filed on Oct. 28, 2024.
(60) Provisional application No. 63/712,580, filed on Oct. 28, 2024.
(60) Provisional application No. 63/712,849, filed on Oct. 28, 2024.
(60) Provisional application No. 63/712,636, filed on Oct. 28, 2024.

(51) Int. Cl. G07C 5/08

(52) U.S. Cl. CPC G07C 5/0808; G07C 5/0816

(57) ABSTRACT

Systems and methods for monitoring a vehicle are provided herein. The system includes a first sensor configured to detect at least one parameter of a vehicle and at least one controller communicably coupled to the first sensor. The controller includes a processor and a memory storing code. The code includes instructions that when executed by the processor cause the processor to receive, from the first sensor, a signal indicating the at least one parameter. The instructions cause the processor determine a state associated with the vehicle based on the at least one parameter, determine, based on the state and a target state, if the vehicle is in a target configuration, and perform, based on the vehicle being in the target configuration, an automated control action. The automated control action includes providing a first alert indicating that the vehicle is in the target configuration.

### CROSS-REFERENCE TO RELATED PATENT APPLICATION

This application claims the benefit of and priority to (a) U.S. Provisional Patent Application 63/712,849, filed on Oct. 28, 2024, (b) U.S. Provisional Patent Application 63/712,580, filed on Oct. 28, 2024, (c) U.S. Provisional Patent Application 63/712,636, filed on Oct. 28, 2024, and (d) U.S. Provisional Patent Application 63/712,618, filed on Oct. 28, 2024, each of which is incorporated herein by reference in its entirety.

### BACKGROUND

The present disclosure relates generally to vehicles and/or work machines. More specifically, the present disclosure relates to vehicles that may be utilized at a jobsite or vocational vehicles. The present disclosure also relates to a fork alignment system for work machines.

Vehicles are utilized to transport personnel and equipment between different areas. Vehicles may utilize a drivetrain that consumes power from an onboard energy storage device to operate one or more tractive elements to propel the vehicle. The vehicles may include one or more sensors that facilitate navigation or other operation of the vehicles.

Lift devices include a lift assembly that raises a load above the ground. The lift device may raise the load by inserting a lift fork into the load. An alignment system may position the lift fork near a desired area of the load.

### SUMMARY

At least one embodiment relates to a system for monitoring a vehicle. The system includes a first sensor configured to detect at least one parameter of a vehicle and at least one controller communicably coupled to the first sensor. The controller includes a processor and a memory storing code. The code includes instructions that when executed by the processor cause the processor to receive, from the first sensor, a signal indicating the at least one parameter. The code includes instructions that when executed by the processor cause the processor determine a state associated with the vehicle based on the at least one parameter, determine, based on the state and a target state, if the vehicle is in a target configuration, and perform, based on the vehicle being in the target configuration, an automated control action. The automated control action includes providing a first alert indicating that the vehicle is in the target configuration.

Another embodiment relates to a method for monitoring a vehicle. The method includes receiving, from a sensor, a signal indicating at least one parameter of a vehicle. The method includes determining a state associated with the vehicle based on the at least one parameter and determining, based on the state and a target state, if the vehicle is in a target configuration. The method further includes providing a first alert indicating that the vehicle is in the target configuration.

Another embodiment relates to a system. The system includes a vehicle having one or more components. The system includes one or more sensors. At least one of the one or more sensors is coupled to or separate from the vehicle and configured to detect current parameters of the one or more components of the vehicle. The system includes a controller communicably coupled to the one or more sensors. The controller includes a processor and a memory storing code, the code including instructions that when executed by the processor cause the processor to receive a set of parameters associated with a target state for the vehicle, the set of parameters being associated with the one or more components of the vehicle. The code includes instructions that when executed by the processor cause the processor to receive, from the one or more sensors, data indicative of the current parameters of the one or more components of the vehicle, and compare the current parameters of the one or more components of the vehicle to the set of parameters associated with the target state for the vehicle. The code includes instructions that when executed by the processor cause the processor to operate at least one of the one or more components of the vehicle until the current parameters of the one or more components of the vehicle match the set of parameters for the one or more components of the vehicle.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a block diagram of a vehicle, according to an exemplary embodiment.

FIG. 2 is a block diagram of a system including the vehicle of FIG. 1, according to an exemplary embodiment.

FIG. 3 is a perspective view of a lift machine, according to an exemplary embodiment.

FIG. 4 is a perspective view of the lift machine illustrating the camera fields of view, according to an exemplary embodiment.

FIG. 5 is an example of a top-down view illustrating the camera fields of view, according to an exemplary embodiment, according to an exemplary embodiment.

FIG. 6 is another example of a top-down view illustrating the camera fields of view, according to an exemplary embodiment.

FIG. 7 is another example of a top-down view illustrating the camera fields of view, according to an exemplary embodiment.

FIG. 8 is a flowchart illustrating a method for capturing and processing images in a lift machine, according to an exemplary embodiment.

FIG. 9 is block diagram of a shipping readiness system for a vehicle, according to an exemplary embodiment.

FIG. 10 is a perspective view of a vehicle, according to an exemplary embodiment.

FIG. 11 is a perspective view of the vehicle of FIG. 10 in a shipping, transport, or storage configuration, according to an exemplary embodiment.

FIG. 12 is a side view of the vehicle of FIG. 10 in a shipping, transport, or storage configuration, according to an exemplary embodiment.

FIG. 13 is a flow diagram of a method for shipping readiness verification.

FIG. 14. is a block diagram of a vehicle loading system, according to an exemplary embodiment

FIG. 15. is a perspective view of a vehicle, according to an exemplary embodiment.

FIG. 16. is a schematic of a vehicle loading system within a space, according to an exemplary embodiment.

FIG. 17 is a flow diagram of a method of loading a vehicle, according to an exemplary embodiment.

FIG. 18 is a front perspective of a work machine, according to an exemplary embodiment.

FIG. 19 is a right-side view of the work machine of FIG. 18.

FIG. 20 is a rear perspective view of the work machine of FIG. 18.

FIG. 21 is a front perspective of a storage container, according to an exemplary embodiment.

FIG. 22 is a block diagram of a control system of the work machine of FIG. 18, according to an exemplary embodiment.

FIG. 23 is a block diagram of a communication system of the block diagram of FIG. 22, according to an exemplary embodiment.

FIG. 24A is a partial flow diagram of a multi-tiered fork alignment process, according to an exemplary embodiment.

FIG. 24B is a partial flow diagram of a multi-tiered fork alignment process, according to an exemplary embodiment.

FIG. 24C is a partial flow diagram of a multi-tiered fork alignment process, according to an exemplary embodiment.

FIG. 24D is a partial flow diagram of a multi-tiered fork alignment process, according to an exemplary embodiment.

FIG. 25 is a block diagram of a user interface of the control system of the block diagram of FIG. 22, according to an exemplary embodiment.

FIG. 26 is a right-side view of a front-loading refuse vehicle, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

### Vehicle

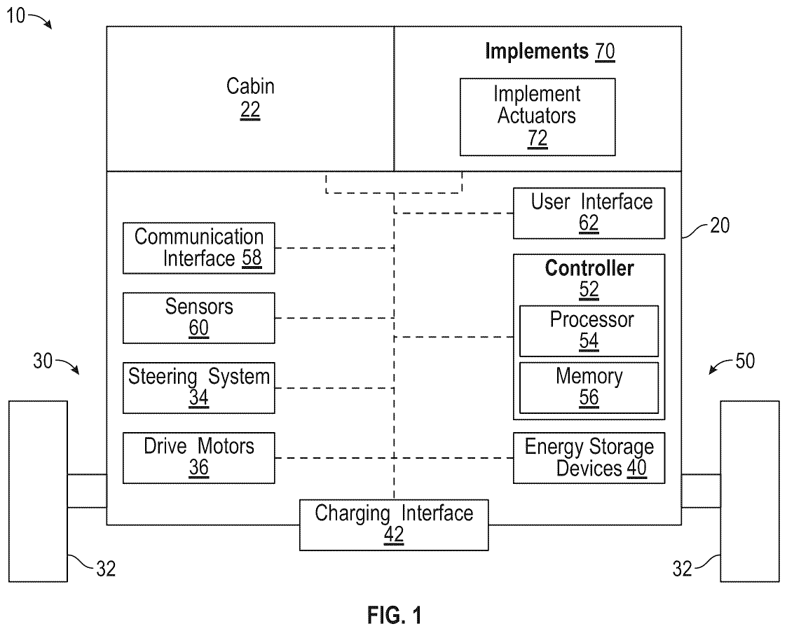

Referring to FIG. 1, a vehicle (e.g., a vocational vehicle, a work machine, etc.), is shown as vehicle 10 according to an exemplary embodiment. By way of example, the vehicle 10 may be a lift device, such as a boom lift, a telehandler, an aerial work platform, a scissor lift, a vertical lift, a compact crawler boom, a forklift, a crane, a bucket truck, or another type of lift device. In other embodiments, the vehicle 10 is another type of vehicle or work machine, such as a military vehicle, a cement truck, a refuse vehicle, a fire apparatus (e.g., a fire truck including a deployable ladder, an aircraft rescue and firefighting truck, etc.), a tow truck, a robot, or another type of vehicle or work machine.

The vehicle 10 includes a frame assembly, housing, or chassis, shown as chassis 20, that supports the other components of the vehicle 10. The chassis 20 may include one or more components (e.g., frame members, housings, etc.) coupled to one another to form the chassis 20. The chassis 20 supports an enclosure, shown as cabin 22, that is configured to house one or more operators of the vehicle 10. The cabin may include one or more doors to facilitate access to the cabin 22.

The vehicle 10 further includes drivetrain or propulsion system, shown as a drivetrain 30, that is configured to propel the vehicle 10. The drivetrain 30 includes one or more tractive elements (e.g., wheel and tire assemblies, tracked assemblies, etc.), shown as wheels 32, rotatably coupled to the chassis 20. The wheels 32 are configured to engage a support surface (e.g., the ground) to support the vehicle 10. The vehicle 10 further includes one or more steering assemblies, shown as steering system 34, coupled to the chassis 20. The steering system 34 is configured to steer or otherwise control a direction of motion of the vehicle 10 (e.g., in response to a command from an operator of the vehicle 10). By way of example, the steering system 34 may include an actuator that pivots one or more of the wheels 32 relative to the chassis 20.

The drivetrain 30 includes one or more actuators, drive motors, or prime movers, shown as drive motors 36, coupled to the chassis 20. In some embodiments, the drive motors 36 include one or more electric motors (e.g., AC motors, DC motors, etc.). In some embodiments, the drive motors 36 include one or more internal combustion engines (e.g., gasoline engines, diesel engines, etc.). In some embodiments, the drive motors 36 include one or more internal combustion engines and one or more electric motors (e.g., forming a hybrid drivetrain). The drive motors 36 are configured to drive one or more of the wheels 32 to propel the vehicle 10. The drive motors 36 may be directly coupled to the wheels 32 and/or indirectly coupled to the wheels 32 (e.g., through a geared transmission, through a hydrostatic transmission, etc.).

The vehicle 10 further includes one or more energy storage devices (e.g., batteries, fuel tanks, etc.), shown as energy storage devices 40, coupled to the chassis 20. The energy storage devices 40 may store energy to power the systems of the vehicle 10 (e.g., the drive motors 36). The energy storage devices 40 may include batteries, fuel cells, fuel tanks, or other types of energy storage devices 40.

The vehicle 10 further includes an energy transfer interface, shown as charging interface 42, coupled to the chassis 20. The charging interface 42 is configured to transfer electrical energy into and/or out of the vehicle 10 (e.g., between the vehicle 10 and an electrical grid, a generator, etc.). The charging interface 42 may supply electrical energy to charge the energy storage devices 40. In some embodiments, the charging interface 42 transfers energy wirelessly. In such embodiments, the charging interface 42 may include a wireless energy transfer coil to transfer energy through induction. In some embodiments, the charging interface 42 is configured to transfer electrical energy through a wired connection. In such embodiments, the charging interface 42 may include a set of electrical contacts positioned to engage a set of external electrical contacts. In other embodiments, the charging interface 42 is omitted.

The vehicle 10 further includes a control system 50 including a controller 52 that controls operation of the vehicle 10. The controller 52 can be operatively coupled to the drive motors 36. The controller 52 includes a processing circuit, shown as processor 54, and a memory device, shown as memory 56. The memory 56 may contain one or more instructions that, when executed by the processor 54, cause the controller 52 to perform the processes described herein. While some processes may be described as being performed by the controller 52, it should be understood that those processes may be performed by any other controller of the system 100 or distributed across multiple controllers of the system 100. The controller 52 may control the drive motors 36 and the steering system 34 to navigate the vehicle 10. In some embodiments, the controller 52 navigates in response to commands from an operator. In some embodiments, the controller 52 navigates the vehicle 10 autonomously (e.g., without any directional control by an operator).

The control system 50 further includes a network interface, shown as communication interface 58, operatively coupled to the controller 52. The communication interface 58 is configured to transfer data between the vehicle 10 and other components of the system 100 (e.g., other vehicles 10, the user devices 102, the servers 104, the network 110, etc.). The communication interface 58 may facilitate wired and/or wireless communication.

The control system 50 further includes one or more sensors 60 operatively coupled to the controller 52. In some embodiments, the sensors 60 provide sensor data relating to the vehicle 10 (e.g., a current status of the vehicle 10). In some embodiments, the sensors 60 provide sensor data relating to the surroundings of the vehicle 10 (e.g., detecting nearby objects, etc.).

The control system 50 further includes a user interface or operator interface, shown as user interface 62, operatively coupled to the controller 52. The user interface 62 may include one or more output devices (e.g., display, speakers, haptic feedback devices, lights, projectors, etc.). In some embodiments, the user interface 62 includes one or more input devices (e.g., buttons, touch screens, microphones, etc.). The user interface 62 may extend within the cabin 22 to facilitate control over the vehicle 10 by an operator positioned within the cabin 22.

The vehicle 10 further includes one or more implement assemblies or end effectors, shown as implements 70. The implements 70 may be utilized by the vehicle 10 interact with the surrounding environment. By way of example, an implement 70 may include a lift assembly such as a boom or a scissor lift. By way of another example, an implement 70 may include lift forks or a grabber to engage or otherwise support an object from the surrounding environment.

The implements 70 may include one or more actuators, shown as implement actuators 72, that facilitate movement of the implements 70. By way of example, the implement actuators 72 may include rotary actuators, such as electric motors or hydraulic motors. By way of another example, the implement actuators 72 may include linear actuators such as hydraulic cylinders or electric linear actuators. The implement actuators 72 may be operatively coupled to the controller 52 to permit the controller 52 to control operation of the implements 70 by moving the implement actuators 72.

### Vehicle System

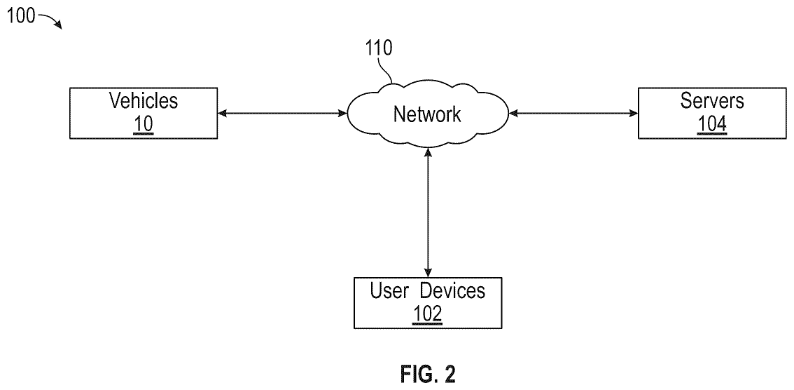

Referring to FIG. 2, the vehicle 10 is part of a vehicle system, work machine system, or jobsite system, shown as system 100, according to an exemplary embodiment. The system 100 may include one or more of the vehicles 10. As shown, the system 100 further includes one or more user interfaces or user devices (e.g., smartphones, tables, laptop computers, desktop computers, pagers, smart speakers, AI assistants, etc.), shown as user devices 102. The user devices 102 facilitate communication between one or more users and the system 100. By way of example, a user may provide a command, such as a command for the vehicle 10 to move to a specific location, through the user device 102. By way of another example, the system 100 may communicate the current location of a vehicle 10 to a user through the user devices 102.

The system 100 further includes one or more cloud devices, storage devices, databases, or vehicle managers, shown as servers 104 (e.g., cloud servers, cloud devices, cloud controllers, etc.). The servers 104 may store and/or process data to facilitate operation of the system 100. The servers 104 may store data and manage the flow of information throughout the system 100. By way of example, the servers 104 may track (e.g., retrieve and store) the current locations of the vehicles 10, the current statuses of the vehicles 10, information regarding authorized users of the system 100, or other information.

The components of the system 100 (e.g., the vehicles 10, the user devices 102, and/or the servers 104) may communicate with one another directly and/or across a network 110 (e.g., a cellular network, the Internet, etc.). In some embodiments, the components of the system 100 communicate wirelessly. By way of example, the system 100 may utilize a cellular network, Bluetooth, near field communication (NFC), infrared communication, radio, or other types of wireless communication. In other embodiments, the system 100 utilizes wired communication.

### Vehicle Camera Monitoring

Referring generally to the figures, the concept involves a vehicle equipped with multiple cameras that provide monitoring through real-time image capture and processing. The systems and methods disclosed herein feature cameras mounted at various points on the vehicle, which can be configured to capture images periodically or when motion is detected. These cameras are capable of tilting, zooming, and rotating to capture different perspectives of the surrounding environment, ensuring thorough surveillance from multiple angles. When motion is detected, the camera can be configured to increase the image capture frequency and can trigger coordinated image capture across other networked vehicles to provide a complete view of the worksite. The captured images are stored and can be used for safety monitoring, security, or operational analysis.

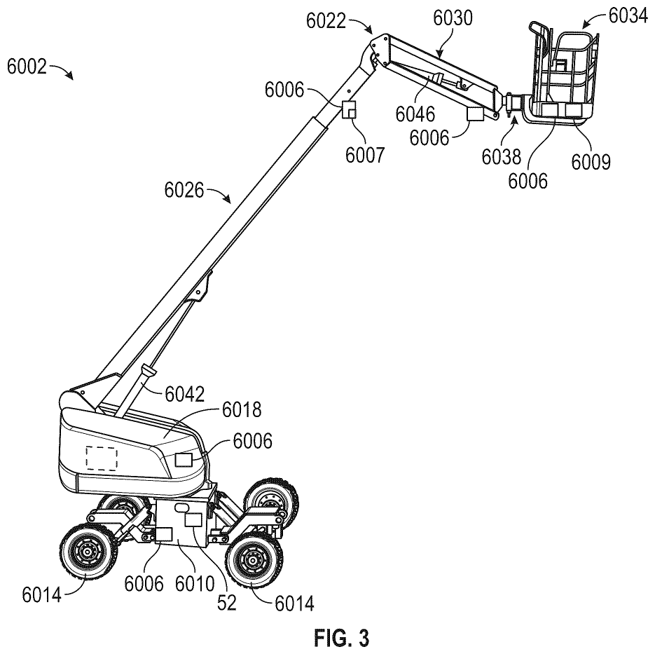

As shown in FIG. 3, a vehicle 6002 can include some or all the elements of vehicle 10. The vehicle 6002 includes a chassis, shown as frame 6010, and a plurality of tractive elements, shown as wheel and tire assemblies 6014. In other embodiments, the tractive elements include track elements. According to the exemplary embodiment shown in FIG. 3, the vehicle 6002 is configured as a lift device or machine. As shown in FIG. 3, the lift device or machine is configured as a boom lift. In other embodiments, the lift device or machine is configured as a skid-loader, a telehandler, a scissor lift, a forklift, and/or still another lift device or machine. As shown in FIG. 3, the frame 6010 supports a rotatable structure, shown as turntable 6018, and a boom assembly, shown as boom 6022. According to an exemplary embodiment, the turntable 6018 is rotatable relative to the frame 6010. According to an exemplary embodiment, the turntable 6018 includes a counterweight positioned at a rear of the turntable 6018. In other embodiments, the counterweight is otherwise positioned and/or at least a portion of the weight thereof is otherwise distributed throughout the vehicle 6002 (e.g., on the frame 6010, on a portion of the boom 6022, etc.).

As shown in FIG. 3, the boom 6022 includes a first boom section, shown as lower boom 6026, and a second boom section, shown as upper boom 6030. In other embodiments, the boom 6022 includes a different number and/or arrangement of boom sections (e.g., one, three, etc.).

According to an exemplary embodiment, the boom 6022 is an articulating boom assembly. In one embodiment, the upper boom 6030 is shorter in length than lower boom 6026. In other embodiments, the upper boom 6030 is longer in length than the lower boom 6026. According to another exemplary embodiment, the boom 6022 is a telescopic, articulating boom assembly. By way of example, the upper boom 6030 and/or the lower boom 6026 may include a plurality of telescoping boom sections that are configured to extend and retract along a longitudinal centerline thereof to selectively increase and decrease a length of the boom 6022.

As shown in FIG. 3, the lower boom 6026 has a lower end pivotally coupled (e.g., pinned, etc.) to the turntable 6018 at a joint or lower boom pivot point. The boom 6022 includes a first actuator (e.g., pneumatic cylinder, electric actuator, hydraulic cylinder, etc.), shown as lower lift cylinder 6042. The lower lift cylinder 6042 has a first end coupled to the turntable 6018 and an opposing second end coupled to the lower boom 6026. According to an exemplary embodiment, the lower lift cylinder 6042 is positioned to raise and lower the lower boom 6026 relative to the turntable 6018 about the lower boom pivot point.

As shown in FIG. 3, the upper boom 6030 has a lower end pivotally coupled (e.g., pinned, etc.) to an upper end of the lower boom 6026 at a joint or upper boom pivot point. The boom 6022 includes an implement, shown as platform assembly 6034, coupled to an upper end of the upper boom 6030 with an extension arm, shown as jib arm 6038. In some embodiments, the jib arm 6038 is configured to facilitate pivoting the platform assembly 6034 about a lateral axis (e.g., pivot the platform assembly 6034 up and down, etc.). In some embodiments, the jib arm 6038 is configured to facilitate pivoting the platform assembly 6034 about a vertical axis (e.g., pivot the platform assembly 6034 left and right, etc.). In some embodiments, the jib arm 6038 is configured to facilitate extending and retracting the platform assembly 6034 relative to the upper boom 6030. As shown in FIG. 3, the boom 6022 includes a second actuator (e.g., pneumatic cylinder, electric actuator, hydraulic cylinder, etc.), shown as upper lift cylinder 6046. According to an exemplary embodiment, the upper lift cylinder 6046 is positioned to actuate (e.g., lift, rotate, elevate, etc.) the upper boom 6030 and the platform assembly 6034 relative to the lower boom 6026 about the upper boom pivot point.

According to an exemplary embodiment, the platform assembly 6034 is a structure that is particularly configured to support one or more workers. In some embodiments, the platform assembly 6034 includes an accessory or tool configured for use by a worker. Such tools may include pneumatic tools (e.g., impact wrench, airbrush, nail gun, ratchet, etc.), plasma cutters, welders, spotlights, etc. In some embodiments, the platform assembly 6034 includes a control panel (e.g., a user interface, a removable or detachable control panel, etc.) to control operation of the vehicle 6002 (e.g., the turntable 6018, the boom 6022, etc.) from the platform assembly 6034 and/or remotely therefrom. In some embodiments, the control panel is additionally or alternatively coupled (e.g., detachably coupled, etc.) to the frame 6010 and/or the turntable 6018. In other embodiments, the platform assembly 6034 includes or is replaced with an accessory and/or tool (e.g., forklift forks, etc.).

As shown in FIG. 3, the vehicle 6002 includes one or more sensors (e.g., sensors 60) shown as cameras 6006. The cameras can be positioned at various locations within the exterior of the vehicle 6002. For example, the cameras may be positioned in the upper boom 6030, the lower boom 6026, the platform assembly 6034, the turntable 6018, and/or the frame 6010. The cameras 6006 can be configured as high-definition cameras to provide clear and detailed images. The cameras 6006 can include features such as wide-angle lenses to capture a broad field of view, which can be useful for monitoring the surroundings during the operation of the vehicle 6002. The cameras 6006 can be equipped with pan, tilt, and/or zoom capabilities to allow for full rotational movement. The cameras 6006 can rotate 360 degrees. The cameras 6006 can include optical and/or digital zoom functionalities. The cameras 6006 can include night vision or infrared capabilities for use in low-light or dark conditions.

In some implementations, the cameras 6006 are configured to withstand outdoor conditions, such as extreme temperatures and inclement weather, to ensure consistent performance in various environments. The cameras 6006 can include physical features such as weatherproof housings. For example, the weatherproof housings can be made of corrosion-resistant materials (e.g., stainless steel or high-impact plastic) to protect the internal components of the cameras 6006 from moisture, dust, and debris. The cameras 6006 can be equipped with seals or gaskets around the lens and other vulnerable areas to prevent water ingress. The cameras 6006 can include shatter-resistant glass or polycarbonate coverings over lenses of the cameras 6006 to protect against impacts from debris or accidental contact.

The cameras 6006 can connect with the vehicle 6002 via the servers 104 (e.g., cloud servers, cloud devices, cloud controllers, etc.), network 110, communication interface 58, and/or user devices 102. The cameras 6006 are configured to transfer data to the vehicle 6002 and other components of the system 100 (e.g., other vehicles 10, the user devices 102, the servers 104, the network 110, etc.). The cameras 6006 can include integrated wireless communication modules, such as Wi-Fi, Bluetooth, or cellular connectivity, which enable the cameras 6006 to connect to the network 110 and transmit data over long distances. In some implementations, the cameras 6006 can communicate through a wired connection via Ethernet or similar cables to ensure stable, high-speed data transmission in environments where wireless signals may be disrupted.

The cameras 6006 can utilize cloud-based servers 104 for data storage and processing. The cameras 6006 can send captured images or video data to the cloud servers in real-time for remote monitoring or analysis. The cameras 6006 can interface with the vehicle 6002 via the communication interface 58 and communicate with controller 52.

In some implementations, the cameras 6006 can be configured to periodically capture images of the area surrounding the vehicle 6002. In some implementations, the cameras 6006 can provide monitoring (e.g., continuous monitoring) of a work environment. In some embodiments, the camera 6006 are configured to capture images in response to one or more events (e.g., time of day, detected motion, command signal, etc.). In some embodiments, the cameras 6006 and/or the vehicle 10 can detect people on a jobsite (e.g., via image recognition, facial recognition, motion detection, etc.) who should not be present and provide an alert/notification/message to an operator alerting them of the person. In some embodiments, the alert/notification/message contains an image of the person. The cameras 6006 periodic image capture can be set at predefined intervals or rates (e.g., 1 min, 5 min, 10 min, 30 min, 1 hour, 5 hours, etc. or 1 image per minute, 10 images per minute, etc.), ensuring the availability of up-to-date visual data of the work environment. The availability of up-to-date visual data of the work environment due to the cameras 6006 periodic images can assist in maintaining a safe work environment. The cameras 6006 may include adaptive image capture scheduling to optimize surveillance. The frequency or rate of image capture by the cameras 6006 may vary depending on different factors (e.g., time of day or environmental conditions). For example, during nighttime or in low-visibility conditions, the cameras 6006 can be configured to increase the image capture frequency to enhance monitoring. In another example, during daylight hours, the cameras 6006 may capture images at a lower frequency.

The images captured by the cameras 6006 may be recorded and stored in a database or server (e.g., server 104) or onboard a vehicle (e.g., memory 56), for later review. For example, when a theft or break-in is suspected, the images captured by the cameras 6006 can provide evidence, allowing operators or security personnel to analyze the recorded footage to identify unauthorized access or suspicious activity. In another example, the images captured by the cameras 6006 can be used to determine causes of accidents. The images captured by the cameras 6006 can be time-stamped. In some embodiments, the images are processed via image recognition to identify one or more people who do not belong in an area (e.g., a jobsite).

In some embodiments, an operating parameter of the cameras 6006 can be changed in response to an event. The operating parameter can be a frequency of image capture, a sensor selection, an image capture setting such as exposure values, focal lengths, or any other operating parameter). The event can be a predetermined event like a time of day or a detected event like a shut-down command, detected motion around the vehicle 10, identification of a person without permission to be in the area. In some embodiments, vehicle 6002 can include one or more motions sensors shown as motion sensors 6007, 6009. In some embodiments, the motion sensors are integrated with, coupled with, and/or mounted on the cameras 6006, such as motion sensors 6007. In some embodiments, the motion sensors are separate from the cameras 6006, such as motion sensors 6009. Upon detecting motion, the motion sensors 6007 or the motion sensors 6009 can generate signals to automatically activate the cameras 6006 to capture images or record video. The motion sensors 6007, 6009 can be based on detecting changes in infrared radiation (e.g., passive infrared (PIR) sensors) or in detecting sound waves to identify movement (e.g., ultrasonic sensors). The motion sensors 6007, 6009 can be calibrated to sensitivity levels, which can allow the motion sensors to differentiate between routine, harmless activities (e.g., tree branches swaying) and movements (e.g., a person or object approaching the vehicle 6002). The motion sensors 6007, 6009 can be adjusted to filter out minor or irrelevant movements, reducing false triggers and focusing the image capture on significant events. The motion sensors 6007, 6009 can be configured to detect movement within a predefined range and can activate the cameras 6006 to capture images or record video in response to detecting movement within the predefined range.

When an event is detected (e.g., motion), either by the motion sensors 6007, 6009 or based on a review of multiple images from the cameras 6006, the controller 52, or the cameras 6006 themselves, can control the cameras 6006 to automatically increase the frequency of image capture to provide more detailed and continuous monitoring of the work environment. For example, under normal conditions, the cameras 6006 may capture an image once every minute, but upon detecting motion, such as a person entering a vicinity of the vehicle 6002, the frequency of image capture can be automatically increased to every few seconds. In some examples, when motion is detected in low-light conditions, the frequency of image capture may be increased relative to daytime/standard light conditions, and the controller 52 may activate infrared or night vision capabilities. The increase in frequency allows the cameras 6006 to provide a more detailed visual record of the detected motion, which can identify potential security risks or operational changes.

In another embodiment, the detected motion could trigger other actions within the system 100. For example, upon detecting motion, the cameras 6006 and/or controller 52 can alert operators or security personnel via the user devices 102 through the network 110. The captured images can be uploaded to the server 104 for immediate review (e.g., by a fleet manager, by a provider of the vehicle 6002, etc.).

In some embodiments, the detection of motion by motion sensors 6007, 6009 on one machine and/or vehicle, such as vehicle 6002, can trigger image capture across other machines or vehicles 10 within the system 100. The vehicles 10 can be connected via the network 110, that links multiple vehicles with their own respective cameras 6006. When motion is detected by one camera 6006 motion sensor, a signal can be sent to other connected vehicles 10 to prompt the cameras 6006 of the other connected vehicles 10 to initiate or increase their image capture frequency. For example, if vehicle 6002, via the cameras 6006 and the motion sensors within the cameras 6006, detect movement near its work environment, the cameras 6006 on nearby machines, such as additional vehicles 10 or other lift machines, can be triggered (e.g., by the controller 52) to begin capturing images or recording video. In this way, the entire perimeter or surrounding area of the vehicles 10 can be monitored from multiple angles by multiple work machines (e.g., other vehicles 10, lift machines, etc.). In another example, in a construction site scenario, if one vehicle 6002/vehicle 10 detects the presence of a worker entering a hazardous area, all other machines (e.g., other vehicles 10) can increase their image capture frequency, providing operators with a detailed, real-time view of any unusual behavior.

The cameras 6006 may be mounted on the bottom of an aerial work platform (AWP) (e.g., platform assembly 6034) to provide enhanced monitoring of the area directly beneath the AWP during operation. In such an embodiment, the placement of the cameras 6006 on the underside of the AWP allows operators to have a clear view of the ground and the surroundings below the platform. For example, in scenarios where the platform assembly 6034 is elevated, the camera 6006 mounted on the bottom can capture images or video of the area beneath the platform assembly 6034 to ensure that no obstacles, equipment, or personnel are in the way when the platform assembly 6034 is lowered. The cameras 6006 can be equipped with wide-angle lenses to cover a broad area beneath the platform assembly 6034.

In one embodiment, the bottom-mounted camera 6006 can work in conjunction with the motion sensors 6007, 6009. If movement is detected below the platform assembly 6034, the camera 6006 can automatically begin capturing images or video at an increased frequency to closely monitor the activity. This is particularly useful in dynamic work environments where workers or vehicles may inadvertently move into the area under the platform, allowing the operator to take immediate action. The cameras 6006, via the network 110, may transmit real-time images to the operator or other networked machines. For example, when motion is detected by the cameras 6006 on the bottom of the platform assembly 6034, the cameras 6006 can trigger image capture from other cameras 6006 positioned on nearby machines or vehicles 10, providing a complete view of the work environment from multiple perspectives.

In some implementations, the vehicle 6002 can automatically trigger the upper boom 6030 and/or the boom 6022 to raise at a predetermined event or in response to a user input to optimize the cameras 6006 views. The predetermined event can be a time of day such as the end of the workday, a shut-down command or a signal, or shut-down command or signal during a predetermined time of day. In some embodiments, at the end of the day, the upper boom 6030 and/or the boom 6022 of the vehicle 6002 can be raised to position the cameras 6006 at an elevated height, providing the largest possible viewing area. By raising the upper boom 6030 and/or the boom 6022, the cameras 6006 can gain a higher vantage point, allowing them to capture a broader perspective of the area, which can aide in end-of-day monitoring, security, and operational oversight. In one embodiment, the raised positions of the upper boom 6030 and/or the boom 6022 can allow the cameras 6006 to oversee adjacent work zones or entry points, thereby enhancing overall site surveillance.

In some implementations, the vehicle 6002 can automatically trigger the upper boom 6030 and/or the boom 6022 to raise such that the cameras' 6006 field of views (FOVs) can overlap with other vehicle's cameras FOV. For example, as one vehicle 6002 boom 6022 is raised, the system 100 can calculate whether the cameras 6006 on nearby vehicles 10 can provide overlapping coverage. If a gap is detected, the booms 6022 of adjacent vehicles 10 can be automatically adjusted until the cameras' 600 FOVs overlap, thereby decreasing blind spots.

In some implementations, the system 100 can adjust the height of the boom 6022 based on environmental conditions. For example, the cameras 6006 can be raised to the maximum height at which visual markers can remain detected. Visual markers can include reflective tape or paint on the vehicle 6002, lanyards worn by workers, and/or site markers (e.g., traffic cones, signs, or boundary lines, etc.). The cameras 6006 can use visual feedback to detect visual markers and adjust the vehicle 6002 height (e.g., adjusting the boom 6022, the platform assembly 6034, etc.) to ensure the visual markers remains visible. For example, during adverse weather conditions, such as heavy fog, rain, or snow, the vehicle 6002 can automatically lower the boom 6022 to maintain visibility and clarity of the visual markers. When visibility is reduced beyond a threshold, the vehicle 6002 can lower the boom 6022 incrementally until the cameras 6006 can once again detect visual markers. In another embodiment, the vehicle 6002 can vary the boom 6022 height based on the type of marker detected. For example, the vehicle 6002 can prioritize maintaining visibility of worker lanyards, ensuring that worker safety gear remains visible at all times during operation.

Images captured by cameras 6006 from multiple machines (e.g., vehicle 10) can be combined to provide a near-complete picture of the entire job site. Each vehicle 10, such as vehicle 6002, may be equipped with cameras 6006 positioned at various angles to capture different perspectives of the site. By leveraging the images from multiple machines (e.g., vehicles 10), a more comprehensive view of the surroundings can be obtained relative to analyzing images collected from cameras 6006 on a single machine. In one embodiment, the servers 104 and/or vehicles 10 (via the controller 52) can, using positions and orientations of each vehicle 10, stitch the captured images together. Each vehicle 10 location, boom height, and camera 6006 orientation can be determined, allowing the servers 104 and/or vehicles 10 (via the controller 52) to map the areas covered by each camera 6006. By combining the images based on such parameters, the servers 104 and/or vehicles 10 (via the controller 52) can generate a complete bird's-eye view of the job site. The servers 104 and/or vehicles 10 (via the controller 52) can align and overlap images to create a seamless, panoramic representation of the entire area.

In addition to providing surveillance and monitoring, the cameras 6006 may assist in detecting the direction of travel, helping operators navigate the vehicle 6002 accurately through the worksite by providing, via the user interface 62 and/or user device 102, real-time visual feedback of the surrounding environment. The cameras 6006 can be configured to detect potential hazards, such as potholes or uneven terrain, and can notify operators or supervisors, via the user interface 62 and/or user device 102. The cameras 6006 may also be the same cameras used to control the movement or operation of the vehicle 6002 in an autonomous mode. The cameras 6006 can detect lanyards to ensure that workers are properly secured while operating on the platform assembly 6034, and can alert operators or supervisors, via the user interface 62 and/or user device 102, if a lanyard is not correctly attached.

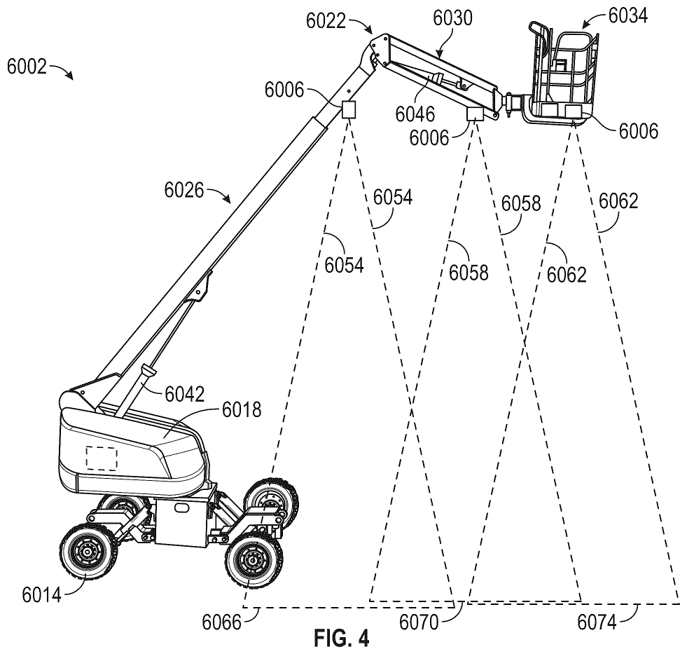

Referring to FIG. 4 in the context of the components described in connection with FIG. 1-3, illustrated is vehicle 6002 equipped with multiple cameras 6006 that provide overlapping fields of view, represented by dashed lines 6054, 6058, 6062, 6066, 6070, and 6074. The dashed lines 6054, 6058, 6062, 6066, 6070, and 6074 represent the camera 6006 coverage areas and/fields of view, which are positioned to monitor different sections of the work environment around the vehicle 6002. The dashed lines 6054, 6058, and 6062 correspond to the fields of view from cameras mounted at various points on the lower boom 6026, upper boom 6030, and platform assembly 6034. These cameras 6006 can provide surveillance and operational monitoring of the area directly beneath and around the elevated platform. Each of the three cameras 6006 presented in FIG. 4 can correspond to a bird's-eye view (e.g., as shown by the dashed lines 6066, 6070, and 6074).

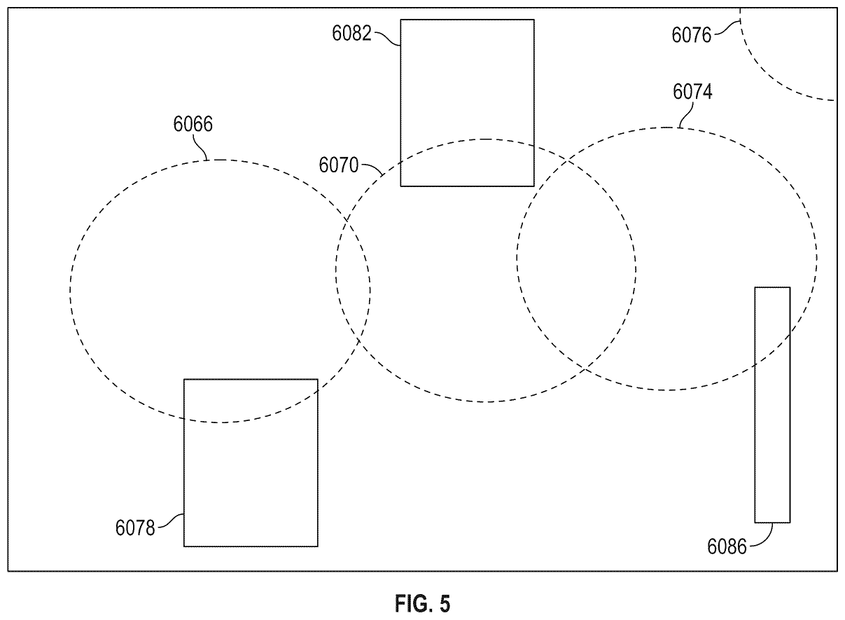

Referring to FIG. 5 in the context of the components described in connection with FIG. 1-4, illustrated is a top-down view of a worksite where cameras 6006 of a vehicle (e.g., vehicle 6002) provide overlapping fields of view. The dashed lines 6066, 6070, and 6074 represent the coverage areas of cameras 6006 mounted on different parts of the vehicle 6002, similar to those depicted in FIG. 4. Each of the dashed lines 6066, 6070, and 6074 corresponds to a camera's 6006 field of view, ensuring comprehensive monitoring of the worksite from multiple angles. In some implementations, the view of the worksite can include coverage areas from cameras 6006 mounted on different vehicles, allowing for even broader monitoring. For example, dashed line 6076 represents the coverage area of a camera 6006 mounted on a different vehicle, providing an additional perspective of the worksite. By adding/integrating the cameras' 6006 field of views from multiple vehicles, the view of the worksite can cover additional angles and areas compared to views covered by the cameras 6006 on a single vehicle.

The objects 6078, 6082, and 6086 can be humans, other equipment, boxes, or machinery positioned throughout the worksite. The overlapping camera fields of view ensure that any movement or activity near these objects can be captured from various perspectives. The overlapping camera fields of view can provide a near-complete bird's-eye view of the worksite. In one embodiment, the cameras 6006 can transmit images to servers 104 and/or vehicles 10 (via the controller 52) to stich individual images into a single, panoramic view of the worksite, as previously described in connection with FIGS. 3 and 4.

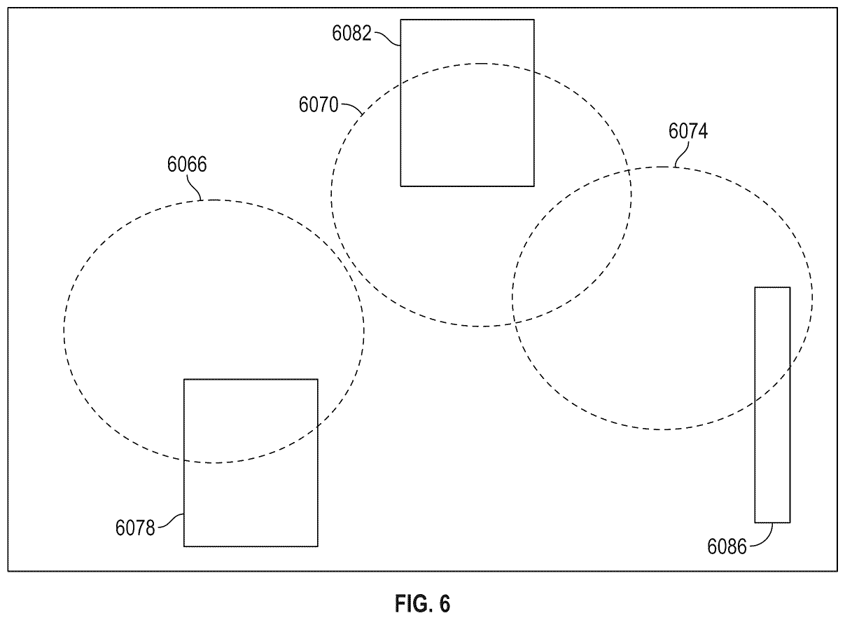

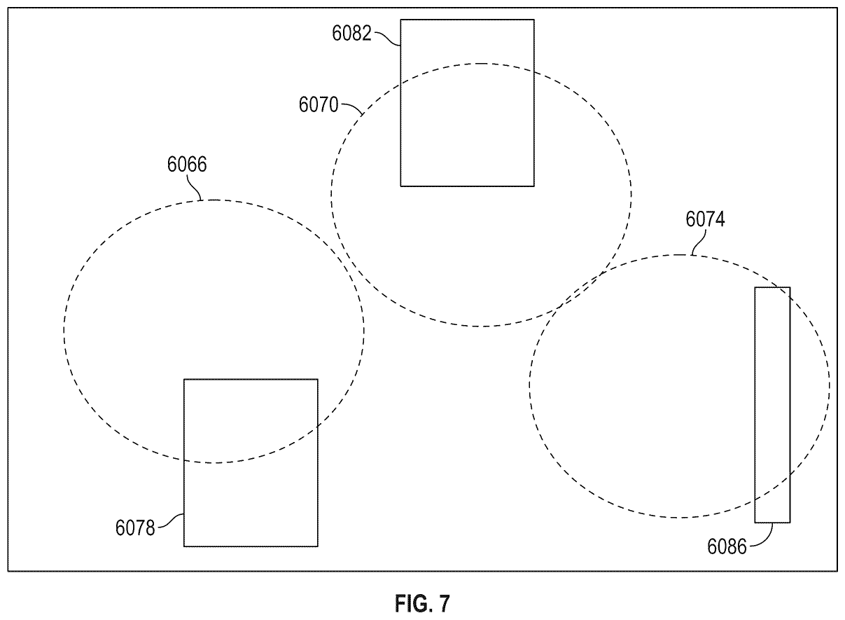

FIGS. 6 and 7 illustrate the same worksite and objects shown in FIG. 5, but with different cameras 6006 tilts to capture different aspects of the environment. The cameras 6006 can be equipped with tilt functionality and can adjust the cameras 6006 angle to provide different perspectives and coverage of the area. This tilt capability enhances the cameras' ability to capture comprehensive visual data across the worksite.

In FIG. 5, the cameras 6006 are shown in one tilt configuration, capturing the areas surrounding objects 6078, 6082, and 6086 from a particular angle. The fields of view, represented by dashed lines 6066, 6070, and 6074, focus on sections of the worksite. FIGS. 6 and 7 illustrate the same scene with the cameras 6006 tilted differently. The cameras 6006 adjustment of the camera angles alters the fields of view, allowing the cameras 6006 to capture different aspects of the same environment, focusing on different aspects around the objects 6078, 6082, and 6086. This ability to tilt the cameras enables the system to monitor both broad and detailed aspects of the worksite, such as overhead views, side angles, or specific equipment zones, depending on the operational requirements.

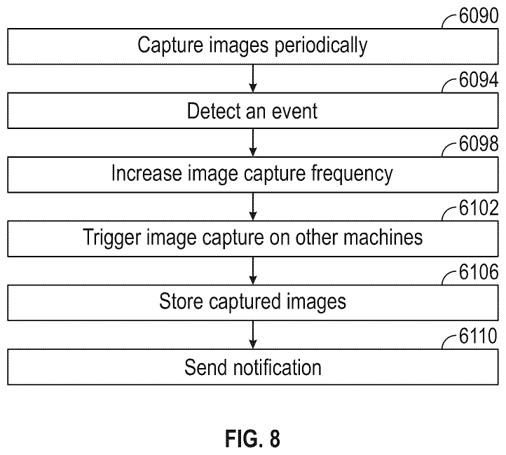

Referring to FIG. 8, illustrated is an example flow diagram of a method for capturing and processing images in a lift machine. In brief overview of the method, the one or more cameras can be mounted on different position of a machinery/vehicle. The cameras are configured to capture images periodically (STEP 6090) to provide consistent monitoring of the surrounding environment. The cameras can detect an event (such as motion, heat, sound, or an incoming signal from another machine, etc.) (STEP 6094), which can cause one or more of the operating parameters of the cameras to change, such as an increase in the image capture frequency (STEP 6098) to ensure detailed and continuous monitoring. The cameras can trigger image capture on other vehicles and/or machinery (STEP 6102), coordinating multiple vehicles and cameras to provide comprehensive coverage of the site. The method can include the captured images (STEP 6106) for review and analysis. The review and analysis may be immediate or at a later time. The review and analysis can include identifying if a person is present in the images. The review and analysis can include determining an identity or access level for the person detected. In some embodiments, this includes performing facial recognition on the person and comparing the image data to a database of people to determine the person's identity or access level. In some embodiments, if the person in the image data does not match a person in the database, the person is determined to not have sufficient access permissions to the jobsite. In some embodiments, if the person is detected outside of operating hours of the jobsite, the person is determined to not have access permissions to the site. The determination can thus be based on one or more factors including identity of the present, time of detection, location, etc. The cameras can send a notification (STEP 6110) to operators or security personnel regarding the detected motion and captured images. In some embodiments where a person is detected who it has determined does not have access permissions to the site at that time, the notification may include an image of the person.

### Telehandler

Referring generally to the FIGURES, the various exemplary embodiments disclosed herein relate to systems, apparatuses, and methods for a shipping readiness system for a vehicle. For example, shipping readiness can include a vehicle configuration that is desirable for shipping. The vehicle configuration can be associated with a configuration that will reduce or prevent damage during shipping. The shipping readiness system may verify that a vehicle such as a lift vehicle, is in a proper shipping configuration. The shipping configuration may define a target state, or set of parameters/conditions in which the vehicle can be safely transported. In some embodiments, the shipping configuration may also reflect a set of parameters or conditions in which the vehicle is stable, space efficient, and/or in an energy saving mode. For example, the shipping configuration may include taut tie downs securing the vehicle to a trailer, set positions for various components coupled to the vehicle (e.g., boom position, arm position, etc.), and/or tire orientation. The shipping configuration, in some embodiments, may define a threshold limit or range for one or more parameters associated with the vehicle. In some embodiments, the shipping configuration may be determined by user input, such as from vehicle handlers, maintenance crews, and the like.

The shipping readiness system receives data from a data acquisition device configured to detect a parameter relating to the vehicle to be shipped. The data acquisition device may include various imaging devices or sensors affixed to the vehicle. The shipping readiness system may receive an input, such as from a user, indicating the type, or model, of the vehicle. In some embodiments, the shipping readiness system may also receive an input indicating a transportation method or trailer/container to be used. The shipping readiness system may use the input to determine a set of parameters associated with the shipping configuration. The shipping readiness system may receive data, such as from the data acquisition device, relating to each parameter of the set of parameters to verify that each parameter is within a limit defined by the shipping configuration.

Upon determining whether the vehicle to be shipped is in the shipping configuration, the shipping readiness system generates a signal indicating shipping readiness. In some embodiments, the signal may include a warning notification that the vehicle is not ready to be shipped, or the signal may include an error message identifying a correction required for shipping readiness. The shipping readiness system may also generate instructions for an operator to verify shipping readiness.

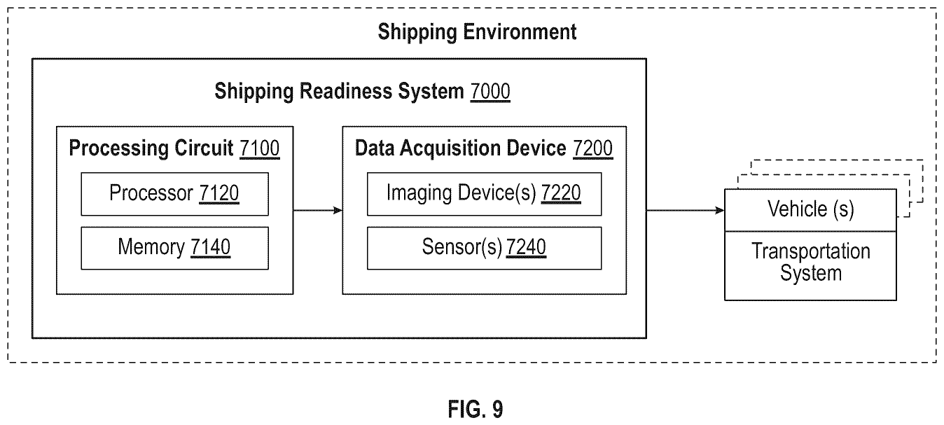

As shown in FIG. 9, the vehicle 10 may be a telehandler 7010. The telehandler 7010, includes chassis 20. The chassis 20 supports the cabin 22, that is configured to house an operator of the telehandler 7010. The telehandler 7010 is supported by wheels 32 that are rotatably coupled to the chassis 20. The wheels 32 are powered to facilitate motion of the telehandler 7010. A manipulator or lift assembly, shown as boom assembly 7304, is pivotally coupled to the telehandler 7010. The telehandler 7010 is configured such that the operator controls the tractive elements 32 and the boom assembly 7304 from within the cabin 22 using a plurality of operator controls (not shown) to manipulate (e.g., move, carry, lift, transfer, etc.) a payload (e.g., pallets, building materials, earth, grains, etc.). In some embodiments, the cabin 22 includes a door 7022 configured to facilitate selective access into the cabin 22. The door 7022 may be located on the lateral side of the cabin 22 opposite the boom assembly 7304.

Each of the wheels 32 may be powered or unpowered. In some embodiments, the telehandler 7010 includes a powertrain system including a primary driver (e.g., an engine, an electric motor, etc.). The primary driver may receive fuel (e.g., gasoline, diesel, natural gas, etc.) from a fuel tank and combust the fuel to generate mechanical energy. According to an exemplary embodiment, the primary driver is a compression-ignition internal combustion engine that utilizes diesel fuel. In alternative embodiments, the primary drivers is another type of device (e.g., spark-ignition engine, fuel cell, etc.) that is otherwise powered (e.g., with gasoline, compressed natural gas, hydrogen, etc.). Additionally, or alternatively, the primary driver include an electric motor that receives electrical energy from energy storage devices 40 (e.g., batteries, capacitors, etc.) or an offboard source of electrical energy (e.g., a power grid, a generator, etc.). In some embodiments, one or more pumps (e.g., a charge pump, an implement pump, and a drive pump) receive the mechanical energy from the primary driver and provide pressurized hydraulic fluid to power the wheels 32 and the other hydraulic components of the telehandler 7010. In some embodiments, the aforementioned charge pump, implement pump, and drive pump provide pressurized hydraulic fluid to drivers or actuators (e.g., hydraulic motors), that are each coupled to one or more of the wheels 32 (e.g., in a hydrostatic transmission arrangement). The drive motors each provide mechanical energy to one or more of the wheels 32 to propel the telehandler 7010. In other embodiments, one drive motor drives all of the tractive elements 32. In other embodiments, the primary driver provides mechanical energy to the wheels 32 through another type of transmission.

The wheels 32 are coupled to chassis 20 by lateral support members, such as axles. Specifically, the two frontmost wheels 32 are coupled to opposite ends of a first axle, and the two rearmost wheels 32 are coupled to opposite ends of a rear axle. The axles are pivotally coupled to the chassis 20 and configured to pivot relative to the chassis 20 about a longitudinal axis, facilitating roll of the chassis 20 about the longitudinal axis. In some embodiments, one or more of the wheels 32 are configured to be steered to control or direct the movement of the telehandler 7010. For example, the telehandler 7010 may include the steering system 34. The telehandler 7010 may include a front steering cylinder that may be coupled to a frontmost axle and coupled (e.g., by one or more tie rods) to each of the frontmost wheels 32. The front steering cylinder is configured to translate laterally to rotate each of the front wheels about a corresponding vertical axis. When the front steering cylinder moves in a first direction from a center position, for example, the wheels 32 turn to steer the telehandler 7010 to the left. When the front steering cylinder moves in a second direction opposite the first direction from the center position, the wheels 32 turn to steer the telehandler 7010 to the right. Likewise, the telehandler 7010 may include a rear steering cylinder that may be coupled to a rearmost axle and coupled to each of the rearmost wheels 32. The rear steering cylinder may then provide steering control of the rearmost wheels 32. In some embodiments, the telehandler 7010 may include a front steering cylinder and a rear steering cylinder that are independently controlled.

Referring again to FIG. 9, the boom assembly 7304 is a telescoping assembly having a series of nested members including a proximal or base section 7306, an intermediate or middle section 7308, and a distal or fly section 7309. The base section 7306 is pivotally coupled to the rear end of the chassis 20 such that the boom assembly 7304 is pivotable about a lateral axis. More particularly, the boom assembly 7304 may be coupled to the telehandler 7010 at a boom pivot. The middle section 7308 is received within the base section 7306 and extends outward beyond the base section 7306. The fly section 7309 is received within the middle section 7308 and extends outward beyond the middle section 7308. In other embodiments, the middle section 7308 is omitted, and the fly section 7309 is received directly within the base section 7306. In other embodiments, the boom assembly 7304 includes multiple middle sections 7308. The base section 7306, the middle section 7308, and the fly section 7309, are each slidably coupled to one another to facilitate varying an overall length of the boom assembly 7304.

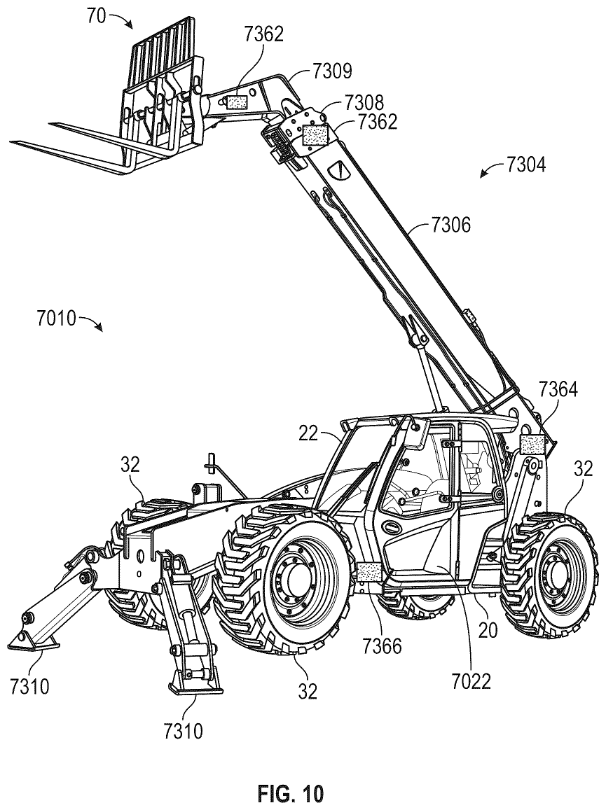

The boom assembly 7304 further includes the implement (e.g., tool, manipulator, interface or implement, etc.) 70 coupled to a distal end of the fly section 7309. The implement 70 may be pivotally coupled to the fly section 7309 such that the implement 70 is pivotable relative to the fly section 7309 about a lateral axis. The implement 70 may facilitate interfacing the boom assembly 7304 with materials (e.g., wood, hay, building materials, etc.) or one or more operators or users. The implement 70 may be powered (e.g., by pressurized hydraulic fluid from a hydraulic system) or unpowered. As shown in FIG. 10, the implement 70 is a fork mechanism comprising a plurality of tines which are configured to lift a palletized payload. For example, the implement 70 can be a pair of forks (e.g., two fork tines), such as forks structured to lift a pallet. In other embodiments, the implement 70 is a bucket, a material handling arm, a boom, a hook, a hopper, a sweeper, a grapple, or another type of implement configured to handle material. In other embodiments, the implement 70 is a work platform configured to support one or more operators. In some embodiments, the implement 70 is selectively coupled to the fly section 7309 such that the implement 70 is interchangeable with other implements. For example, the forks shown in FIG. 9 may be removed and exchanged with a bucket or work platform.

Still referring to FIG. 9, the boom assembly 7304 is articulated by a series of actuators. In some embodiments, the actuators are powered by pressurized hydraulic fluid. The telehandler 7010 includes a first lift cylinder (e.g., a linear actuator). A lower end the lift cylinder is coupled to the chassis 20, and an upper end of the lift cylinder is coupled to the base section 7306. In one embodiment, two lift cylinders may be utilized, with a lift cylinder positioned on an opposing side of the boom assembly 7304 to facilitate an even distribution of the load of the boom assembly 7304. When the lift cylinder extends, the boom assembly is raised. When the lift cylinders retract, the boom assembly 7304 is lowered.

The telehandler 7010 further includes a telescoping cylinder (e.g., a second linear actuator) to control the boom assembly 7304. A proximal end of the telescoping cylinder is coupled to the base section 7306, and a distal end of the telescoping cylinder is coupled to the middle section 7308. When the telescoping cylinder is extended, the middle section 7308 moves longitudinally outward from the base section 7306. When the telescoping cylinder is retracted, the middle section 7308 moves back into the base section 7306.

A tensile member, or cable (e.g., a rope, a strap, a chain, etc.) includes a first end coupled to the base section 7306 and a second end that is coupled to the fly section 7309. The cable extends from the base section 7306, around a distal end of the middle section 7308, and attaches to a portion of the fly section 7309 that is received within the middle section 7308. Accordingly, when the telescoping cylinder extends, moving the middle section 7308 outward, the middle section 7308 applies a tensile force to the cable, which draws the fly section 7309 out of the middle section 7308. A similar cable arrangement may be utilized to retract the fly section 7309 into the middle section 7308 when the middle section 7308 retracts into the base section 7306. Accordingly, the extension of the telescoping cylinder both (a) extends the middle section 7308 relative to the base section 7306 and (b) extends the fly section 7309 relative to the middle section 7308. Similarly, the retraction of the telescoping cylinder both (a) retracts the middle section 7308 relative to the base section 7306 and (b) retracts the fly section 7309 relative to the middle section 7308.

The telehandler 7010 further includes a tilt cylinder (e.g., a third linear actuator). A proximal end of the tilt cylinder is coupled to the fly section 7309, and a distal end of the tilt cylinder is coupled to the implement 70. When the tilt cylinder is retracted, the implement 70 rotates in a first direction (e.g., downward) relative to the fly section 7309. When the tilt cylinder is extended, the implement 70 rotates in a second direction (e.g., upward) relative to the fly section 7309.

The telehandler 7010 may further include two or more stabilizers, shown as stabilizers 7310. The stabilizers 7310 may be positioned proximate to the two frontmost wheels 32 and coupled to the chassis 20. Each of the stabilizers 7310 may further be configured to rotate relative to the chassis 20 such that the stabilizers 7310 may be rotated in a first direction (e.g., downwards) so that the stabilizers 7310 come into contact with a ground surface, as is shown in FIG. 10. When rotated into a downward position, the stabilizers 7310 may be configured to lift a front end of the telehandler 7010 off of a ground surface such that the two frontmost wheels 32 are not in contact with a ground surface, according to an exemplary embodiment. In another embodiment, the two frontmost wheels 32 may remain in contact with a ground surface while the stabilizers 7310 are engaged with the ground surface. The stabilizers 7310 may further be configured to rotate in a second direction (e.g., upwards) so that the stabilizers 7310 may disengage the ground surface or may be lifted off of the ground surface. The stabilizers 7310 may be actuated via a stabilizer cylinder. According to one embodiment, the stabilizer cylinder may be configured to rotate the stabilizer 7310 upwards and downwards as the stabilizer cylinder is retracted or extended.

The telehandler 7010 may further include a control system 50 configured to monitor one or more sensors 60 associated with the telehandler 7010, or control the telehandler 7010. The one or more sensors 60 may include vehicle base inclination sensors 7366, rotation sensors 7364, and/or boom length sensors 7362. The vehicle base inclination sensor 7366 may be configured to determine an angular orientation of the chassis 20 of the telehandler 7010 relative to a reference plane. According to an exemplary embodiment, the vehicle base inclination sensor 7366 may be configured to determine the angular orientation of the chassis 20 relative to a horizontal reference plane. The vehicle base inclination sensor 7366 may be an inclinometer or similar tilt sensor device. The vehicle base inclination sensor 7366 may be configured to determine the angular orientation of the chassis 20 with respect to one, two, or more axes (e.g., a pitch axis and a roll axis). Furthermore, one or more vehicle base inclination sensors 7366 may be disposed about the chassis 20.

The rotation sensors 7364 may be configured to measure the angular orientation of the boom assembly 7304 relative to the telehandler 7010. More particularly, the rotation sensor 7364 may measure the rotation of the boom assembly 7304 about a pivot. The rotation sensor 7364 may be further configured to transmit data regarding the rotation of the boom assembly 7304, where the data regarding the rotation of lift arm indicates whether the lift arm is in a lowered position, a raised position, or some other position therebetween. The rotation sensor 7364 may be a magnetic angle sensors, an optical rotation sensor, a rotary potentiometer, an encoder device, or the like.

The boom length sensor 7362 may be positioned at one or more positions along the boom assembly 7304 to measure the extended length of the boom assembly 7304. According to an exemplary embodiment, three or more boom length sensors 7362 may be implemented to measure the position of each lift arm segment (e.g., base section 7306, middle section 7308, and fly section 7309). The boom length sensors 7362 may be configured to determine the extended length of the boom assembly 7304 by measuring linear movement (e.g., linear extension/retraction of the boom assembly 7304) or rotational movement. The boom length sensor 7362 may thus be a rotation sensor similar to the rotation sensors 7364 described above, or the boom length sensor 7362 may be a linear position sensor, such as a cable-based length sensor, a laser-based length sensor, or the like.

### Shipping Readiness System

The vehicle 10 may be transported (e.g., shipped, delivered, moved, etc.) between locations, such as between job sites, or between a supplier and a customer. The vehicle 10 may be transported on a trailer (e.g., a flatbed trailer, lowboy trailer, enclosed trailer) or in a shipping container. Prior to shipping, the vehicle 10 is placed in a target configuration such as a shipping, transport, or storage mode (e.g., a shipping configuration) such that it can be safely and securely transported. The target configuration can be based on one or more parameters of the vehicle, one or more parameters of the transportation method used to transport the vehicle, and/or one or more parameters of the route the vehicle will be transported along.

Referring now to FIG. 10, the vehicle (e.g., vehicle 10) shown as telehandler 7010, is shown in the shipping configuration 7510. The telehandler 7010 may be transported in a target configuration shown such as a shipping configuration 7510 to prevent or reduce an incidence of an unstable condition of the vehicle 10 during transport, maintain the structural integrity of the telehandler 7010, or reduce an overall footprint of the telehandler 7010 to provide more efficient storage and transportation. The shipping configuration 7510 may define a set of parameters or conditions in which the telehandler 7010 can be safely and efficiently stored or shipped. In some embodiments, the shipping configuration 7510 may define a maximum height during transportation. The maximum height may provide greater vertical clearance such that the telehandler 7010 can be more easily transported through low clearance environments (e.g., bridges, tunnels, etc.) and lowers the overall center of gravity, improving stability and reducing tip. In some embodiments, the shipping configuration may define a maximum extension of the boom assembly 7304. In some embodiments, the shipping configuration 7510 may define a threshold boom angle of the boom assembly 7304. The threshold boom angle may represent an angle of incline of the boom assembly 7304 that, when exceeded, results in a reduced stability of the telehandler 7010. In some embodiments, the shipping configuration 7510 may define a threshold angle of the chassis 20 of the telehandler 7010 associated with instability.

The shipping configuration 7510 may define a set of parameters to ensure proper maintenance and functioning of the telehandler 7010 prior to shipping. In some embodiments, the shipping configuration 7510 may define parameters relating to fluid levels (e.g., oil, hydraulic fluid, coolant, etc.), tire pressure, tire wear, and/or the presence of leaks/mechanical issues. In some embodiments, the shipping configuration 7510 may define parameters relating to cleanliness, such as the presence of debris within the cabin 22, or on the exterior of the telehandler 7010. In some embodiments, the shipping configuration 7510 may require all systems to be powered off, or for any batteries to be disconnected to prevent accidental activation during transport.

The shipping configuration 7510 may define parameters in which the telehandler 7010 is secured. For example, the parameters may relate to properly installed securing constraints (e.g., attachments, chains, straps, tie-downs, securing devices, etc.). For example, the shipping configuration 7510 may define a threshold level of tautness for constraints to ensure the attachments are tight, define a number of attachment points that must secured, or define a proper rating of the constraints for the telehandler 7010. In some embodiments, the shipping configuration 7510 may require any extending parts to be lowered/retracted, or secured to the telehandler 7010. For example, the shipping configuration 7510 of the telehandler 7010 shown in FIG. 4 requires the boom assembly 7304 to be lowered, or in a folded position. As another example, the shipping configuration 7510 shown in FIG. 5 requires the implement 70 and stabilizers 7310 of the telehandler 7010 to be removed. In some embodiments, the shipping configuration 7510 may require various safety features to be engaged, or require a transport mode of the telehandler 7010 to be set to limit movement.

The shipping configuration 7510 may define parameters indicating shipping readiness with relation to a transport vehicle. In some embodiments, the shipping configuration 7510 may define a maximum length, width, and height dimensions associated with a particular type of shipping container or trailer. In some embodiments, the shipping configuration 7510 may define a location of the telehandler 7010 on the transport vehicle such that the weight of the telehandler 7010 is evenly distributed to avoid tipping.

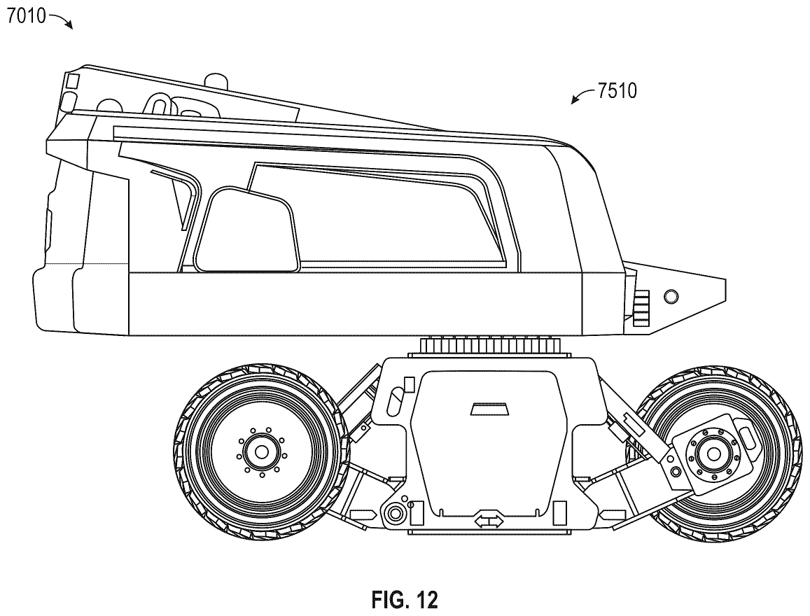

Referring to FIG. 12, a shipping readiness system 7000 may be used in a shipping environment to determine and/or indicate whether a vehicle, such as the telehandler 7010 in FIG. 10, is ready to be shipped. Although the vehicle 10 shown and described herein is a telehandler, in other embodiments, the systems and methods described herein may be utilized with another type of vehicle 10. For example, the vehicle 10 may be an aerial work platform, a scissor lift, a vertical lift, a boom lift, or another type of lift vehicle.

The shipping readiness system 7000 includes a controller 7050 and a data acquisition device 7200. The data acquisition device 7200 includes at least one of an imaging device (e.g., cameras, thermal imaging cameras, x-ray machines, light detection and ranging (LiDAR), endoscopic cameras, drones, barcode and/or QR code scanners, digital scales, image recognition cameras, etc.) 7220 or a sensor 7240 (for example, the one or more sensors 60, and the rotation sensors 7364 and boom length sensors 7362 of FIG. 10). The imaging device 7220 or sensor 7240 may be coupled to the telehandler 7010, or operably coupled to the telehandler 7010. The data acquisition device 7200 may be configured to receive a continuous data stream, periodic data transmission, or sporadic data transmission from the sensor 7240 and/or the imaging device 7220. The data acquisition device 7200 may be actuated by a user input, by detection of a predetermined parameters, etc. The data acquisition device 7200 may be communicably coupled to one or more vehicles 10 to obtain signals and data from sensors, such as sensors 7240, that may be coupled to the vehicle 10.

The controller 7050 of the shipping readiness system 7000 includes a processing circuit 7100 including a processor 7120 and a memory 7140. The processor 7120 may be coupled to the memory 7140. The processor 7120 may be a general purpose or specific purpose processor, an application specific integrated circuit (ASIC), one or more field programmable gate arrays (FPGAs), a group of processing components, or other suitable processing components. The processor 7120 is configured to execute computer code or instructions stored in the memory 7140 or received from other computer readable media (e.g., CDROM, network storage, a remote server, etc.).

The memory 7140 may include one or more devices (e.g., memory units, memory devices, storage devices, etc.) for storing data and/or computer code for completing and/or facilitating the various processes described in the present disclosure. The memory 7140 may include random access memory (RAM), read-only memory (ROM), hard drive storage, temporary storage, non-volatile memory, flash memory, optical memory, or any other suitable memory for storing software objects and/or computer instructions. The memory 7140 may include database components, object code components, script components, or any other type of information structure for supporting the various activities and information structures described in the present disclosure. The memory 7140 may be communicably connected to the processor 7120 via the processing circuit 7100 and may include computer code for executing (e.g., by the processor 7120) one or more of the processes described herein.

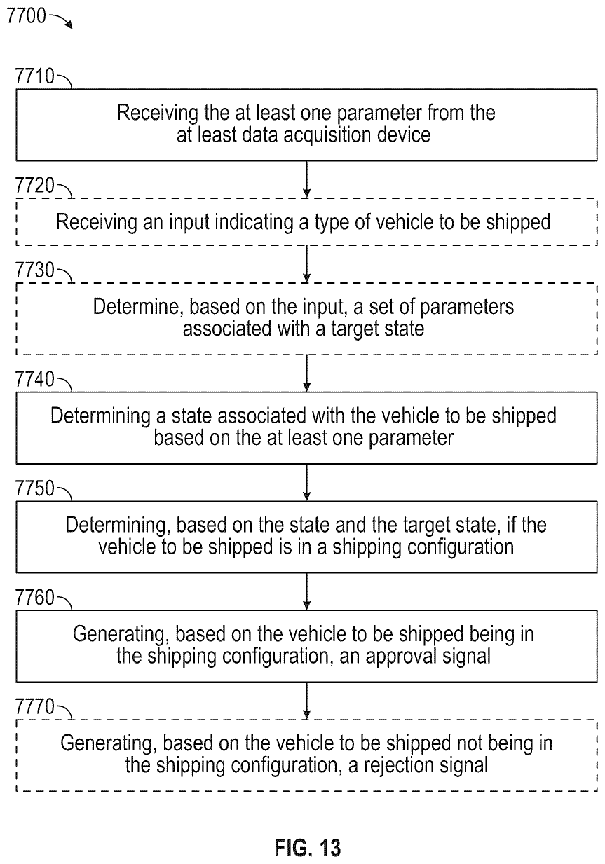

The memory 7140 includes instructions that when executed by the processor 7120 cause the processor 7120 to perform one or more processed. For example, the memory can include instructions for executing a method such as the method 7700 shown in FIG. 13. The instructions can cause the processor 7120 to receive data relating to at least one parameter associated with telehandler 7010 from the data acquisition device 7200. The at least one parameter can include a tire position, implement position/presence, lighting state, and/or whether an attachment is secure. The at least one parameter can also include a boom position, a cab position, etc. For example, the processor 7120 may receive data from the rotation sensors 7364 of the telehandler 7010 measuring rotation of the boom assembly 7304 about a pivot. As another example, the processor 7120 may receive data from the boom length sensor 7362 measuring the extended length of the boom assembly 7304. As another example, the processor 7120 may receive data from an imaging device 7220 that no stabilizers 7310 are attached to the telehandler 7010.

Based on the received data, the processor 7120 may determine a state of the telehandler 7010 based on the at least one parameter. For example, the data from the rotation sensor 7364 may indicate whether the boom assembly 7304 is in a lowered position. As another example, the data from the boom length sensor 7362 may indicate a length of the telehandler 7010. In some embodiments, the data may be image data and the controller 7050 use image recognition to determine a state of the telehandler 7010 based on the data. For example, the received data may include image data including one or more constraints for securing the vehicle 10 to the transport vehicle, and the controller 7050 can use image recognition and other image processing techniques to determine if the constraints are appropriately secured and tightened (i.e., proper tie-down position, too much slack, too little slack, etc.). The determined state may be compared with a target state of the telehandler 7010. The target state may define a target configuration for the telehandler 7010 and target statuses for one or more subsystems thereof (i.e., prime mover is deactivated, hydraulic lift system deactivated, etc.) The parameters defined by the shipping configuration 7510 are associated with a target state of the telehandler 7010. In the target state, the parameters are within a limit, below a threshold value, or satisfy a condition defined by the shipping configuration 7510.

Based on the determined state and a target state, the processor 7120 determines if the vehicle to be shipped is in a target configuration such as the shipping configuration 7510. If the telehandler 7010 is in the shipping configuration 7510, the processor 7120 may perform one or more automated control actions. The automated control actions may include providing an alert such as an approval signal indicating that the telehandler 7010 is approved for shipping. The signal may be sent to a user device, such as the user device 102. The signal may include auditory/and or visual indicators to indicate shipping readiness.

In some embodiments, the shipping readiness system 7000 operates on a range of vehicles 10. The vehicles 10 may comprises vehicles of different types (e.g., telehandler, boom lift, scissor lift, etc.) and each type may have its own target state (i.e., shipping configuration 7510). The controller 7050 may be configured to receive data from the data acquisition device 7200 and determine a type of vehicle from a plurality of vehicle types for a given vehicle 10. Based on the determined type of vehicle, the controller 7050 can then assess if the vehicle 10 is in the target configuration.

In some embodiments, the target configuration such as the shipping configuration 7510 is based on the state of the vehicle 10 as well as the state and/or type of transport vehicle or container the vehicle 10 may be transported on. Each pair of vehicle 10 and transport vehicle may have specific shipping configuration 7150 and set of parameters associated with that shipping configuration 7510.

Referring to FIG. 13, a flow chart of a method 7700 of verifying shipping readiness for a vehicle (e.g., the vehicle 10, the telehandler 7010, etc.) is shown. The method 7700 may be performed by a processing circuit, such as the processing circuit 7100 as described above with reference to FIG. 9, according to an exemplary embodiment.

At 7710, the processing circuit 7100 may receive data relating to at least one parameter associated with a vehicle to be shipped from a data acquisition device (e.g., the data acquisition device 7200), including at least one of an imaging device or a sensor (e.g., one or more sensors 60, rotation sensors 7364, boom length sensors 7362, etc.) The processing circuit 7100 may receive data from a variety of sensors, imaging devices, or other sources.

At 7720, the processing circuit 7100 may receive an input indicating a type, category, or make of vehicle to be shipped. For example, the type may be a telehandler 7010, or a scissor lift, etc. The input may include a product ID that is associated with a type. In some embodiments, the step 7720 is performed prior to step 7710 and receiving data from the data acquisition device. In some embodiments, the input may also indicate a type of the transport vehicle being used to transport the vehicle to be shipped. The input may be a transport or trailer ID that is associated with the type of transport vehicle.

At 7730, the processing circuit 7100 may determine, based on the input, one or more parameters associated with a target state of the vehicle relating to the shipping configuration. The type of vehicle to be shipped and/or the type of transport vehicle may be associated with the set of parameters associated with a target state. For example, an input indicating that the vehicle is a telehandler, such as the telehandler 7010, may be associated with a set of parameters such as height, whether the boom assembly is retracted, or whether an implement has been detached.

At 7740, the processing circuit 7100 may determine a state of the vehicle to be shipped based on the at least one parameter. For example, the state may be a position of one or more portions of the vehicle, a condition of one or more portions of the vehicle, whether lights are on, whether various systems are on, or whether various components are secured/detached. At 7750, the processing circuit 7100 may determine, based on the state and a target state, if the vehicle to be shipped is in a shipping configuration. If the state of the vehicle meets the target state, the vehicle is in the shipping configuration. For example, if the processing circuit 7100 determines a cabin of the vehicle is empty, and a target state requires an empty cabin, the vehicle is in the shipping configuration.

At 7760, the processing circuit 7100 may generate, based on the vehicle to be shipped being in the shipping configuration, an approval signal that the vehicle to be shipped is ready to be shipped. The approval signal may be part of an automated control action performed by the processing circuit 7100. At 7770, the processing circuit 7100 may generate, based on the vehicle to be shipped not being in the shipping configuration, a rejection signal to indicate that that the telehandler is not ready to be shipped. The rejection signal may be part of an automated control action performed by the processing circuit 7100. In some embodiments, the rejection signal may be an alarm that provides a visual and/or audible notification or warning that the telehandler 7010 is not in the shipping configuration. In some embodiments, the rejection signal will indicate to an operator that they should perform one or more actions to move the vehicle into a shipping configuration (for example, to move telehandler 7010 into the shipping configuration 7510 the boom assembly 7034 must be lowered). In some embodiments, the automated control action may include controlling the state of the vehicle until the state matches the target state.

### Vehicle Loading System

Referring generally to the FIGURES, a vehicle loading system is shown that is configured to reduce the likelihood of vehicle damage during loading onto a loading transport such as a shipping container, trailer, flat-bed, and/or the like. The vehicle loading system is configured to facilitate the loading process to improve loading efficiency. The vehicle loading system includes a sensor assembly that is selectively and/or removably couplable to a vehicle that can sense position data associated with the vehicle and sense environmental data associated with a space around the vehicle. The position data and environmental data can then be used to guide the vehicle and/or to determine if the vehicle is in an undesired position, such as in close proximity to a surface, thus reducing the likelihood of vehicle damage while increasing operational efficiency.

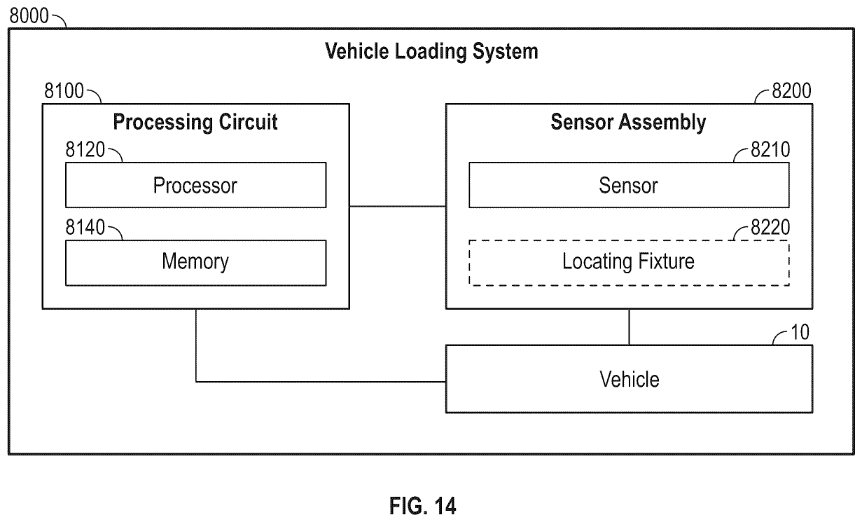

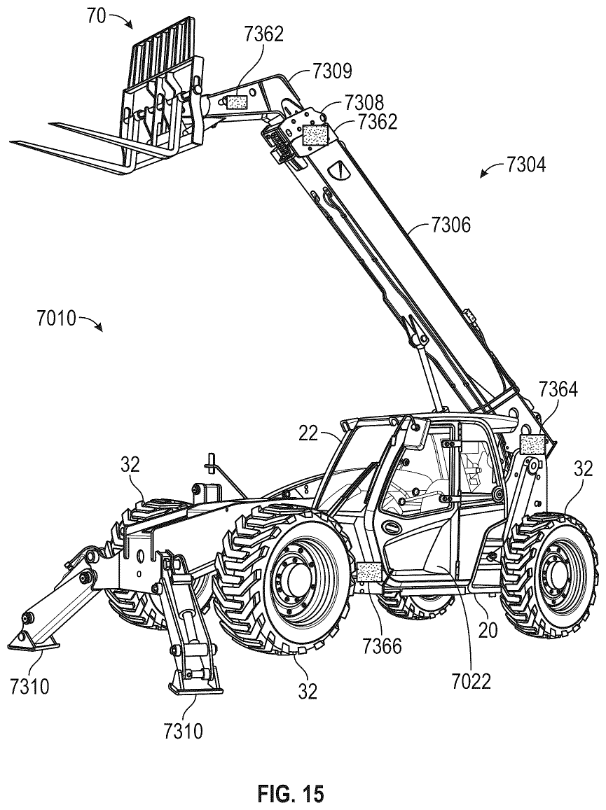

Referring to FIG. 14-16, the vehicle 10, such as the telehandler 7010, may be part of a vehicle loading system 8000 that is configured to facilitate loading the vehicle 10 for transport, or shipping of the vehicle, such as between job sites. For example, the vehicle 10 may be loaded onto a transport platform, such as a trailer or a shipping container. Further, the vehicle 10 may be loaded onto a transport platform via a ramp, or may be moved through narrow, or tight spaces (e.g., compact spaces, spaces with substantially low clearance) prior to shipping. The vehicle loading system 8000 may be used to reduce or prevent damage to the vehicle 10 during loading of the vehicle 10 for storage and/or shipping. The vehicle loading system 8000 further increases the efficiency of loading the vehicle.

The vehicle loading system 8000 includes a sensor assembly 8200 that is removably coupled to the vehicle 10. The sensor assembly 8200 is configured to measure, determine, sense, and/or detect position data associated with the vehicle 10. For example, the sensor assembly 8200 may be configured to sense positions, orientations, and/or configurations associated with one or more portions of the vehicle 10. The sensor assembly 8200, may, for example, sense position data including the implement 70 for example, the boom assembly 7304 of the telehandler 7010. The sensor assembly 8200 is further configured to sense environment data of a space surrounding the vehicle 10. For example, environment data may include at least one of a surface mapping of the space surrounding the vehicle, proximity of surfaces surrounding the vehicle, and/or the like. The space, for example, may include a narrow hallway, a shipping container, trailer (e.g., flatbed trailer, etc.), a platform, and/or the like. The sensor assembly 8200 may be removably coupled to the vehicle 10 during loading of the vehicle 10 for shipping and removed from the vehicle 10 during normal operation of the vehicle 10. For example, the sensor assembly 8200 may be removably coupled to the vehicle before or during the vehicle 10 engaging a tight space such as before loading into a shipping container. After the vehicle 10 is safely loaded into a desired position, the sensor assembly 8200 may be removed so that the vehicle 10 may be shipped. Selective and/or removable coupling of the sensor assembly 8200 allows for the sensor assembly 8200 to be reused for multiple vehicles 10, thus reducing overall cost as the sensor assembly 8200 is coupled to the vehicle 10 as needed. However, in some embodiments, one or more portions of the sensor assembly 8200 may be permanently coupled for the vehicle 10.

The vehicle 10 includes one or more mounting points 8010 configured to receive one or more portions of the sensor assembly 8200. The one or more mounting points 8010 may be disposed around the perimeter of the vehicle 10 such that the sensor assembly 8200 may have a desired coverage (e.g., each portion is visible, outermost portions are visible, etc.) of the vehicle 10 and the space surrounding the vehicle 10. For example, desired coverage may include coverage (e.g., visibility, sensing range, etc.) of the outermost portions of the vehicle 10 such as the wheels 32 of the vehicle 10. In some embodiments, the one or more mounting points 8010 may be disposed along or substantially near an outermost edge of the vehicle 10. For example, the one or more mounting points may be disposed on an implement 70 of a telehandler 7010. In some embodiments, the one or more mounting points 8010 may include an anterior mounting point, a first later mounting point, a second lateral mounting point opposite the first lateral mounting point, and a posterior mounting point. The one or more mounting points 8010 may include at least a portion of a fastener (e.g., clip, slot, hole, pin, hook and loop, plate, groove, etc.), a surface to receive an adhesive, a surface to receive a suction cup, a magnet, and/or the like. In some embodiments, the one or more mounting points 8010 includes a coupler portion that is configured to receive a corresponding coupler portion of the sensor assembly 8200.

The sensor assembly 8200 includes a sensor 8210 and, optionally, a locating fixture 8220. The sensor 8210 is configured to sense position data associated with the vehicle 10 and environment data associated with the space surrounding the vehicle 10. The sensor assembly 8200 may be a portion of a vision system. In some embodiments, the sensor assembly 8200 is configured to couple with and/or receive data from a sensor system of the vehicle 10 and/or a control system of the vehicle 10, such as the one or more sensors 60. In some embodiments, the sensor 8210 includes a plurality of sensors. The sensor 8210 may include one or more of a camera, a position sensor, a distance sensor, an ultrasonic sensor, an infrared sensor, a LiDAR, a radar, a pressure sensor, an inertial measurement unit, a global positioning sensor, a proximity sensor, and/or the like. In some embodiments, the sensor assembly 8200 may include multiple sensors 8210 configured to sense position data and environment data in the same area for redundancy and/or improved accuracy. The sensors 8210 may be chosen based on the type of loading and/or shipping of the vehicle 10. For example, different sensors 8210 may be used for loading onto a shipping container and different sensors may be used for loading onto a flatbed trailer. The sensors 8210 are configured to engage the one or more mounting points 8010 of the vehicle 10. The sensors 8210 may include or more mounting features that may receive and/or be received by the mounting points 8010. In some embodiments, the sensors 8210 may include positioning features that guide the sensors 8210 into a desired position when coupling to the one or more mounting points 8010.

The locating fixture 8220 is configured to ensure proper consistent positioning, repeatable positioning, and/or accurate positioning of the sensors 8210 to the one or more mounting points 8010 of the vehicle 10. The locating fixture 8220 may include alignment features (e.g., pins, slots, grooves, etc.) that guide the sensor into a desired position. The locating fixture 8220 may also include mechanical stops that limit movement, ensuring consistent alignment during use. The locating fixture 8220 may also include visual alignment marks that provide visual reference points to maintain consistent positioning. The locating fixture 8220 may be configured to engage one or more portions of the sensors 8210 and/or the one or more mounting points 8010 of the vehicle 10. In some embodiments, the locating fixture 8220 include fasteners, magnets, adhesives, and/or the like for coupling to the one or more mounting points 8010 and/or the sensors 8210. In some embodiments, the locating fixture 8220 is optional.

In some embodiments, the vehicle loading system 8000 may include markers, such as fiducial markers, providing reference points on the vehicle 10 and/or in the space surrounding the vehicle 10 for the at least sensor assembly 8200. In some embodiments, each reference point may have a different marker to allow for traceability. In some embodiments, the markers may be positioned so that they are in view of the sensor 8210. In some embodiments, the markers may be used to determine a position, orientation, and/or configuration or one or more portions of the vehicle 10 and/or the space. The markers may allow for calibration of the sensor assembly 8200 which may allow for increased precision, reliability, and accuracy. In some embodiments, the markers may serve as visual cues for an operator of the vehicle 10. In some embodiments, the positions of the mounting points 8010, the sensors 8200, and/or the markers may vary based on the type of vehicle 10 they coupled to. The controller 8050 can receive via a user input or determine based on the data from the sensor assembly 8200 which type of vehicle is being loaded and adjust the vehicle loading system 8000 accordingly.

Referring now to FIG. 14, the vehicle loading system 8000 includes a controller 8050 including a processing circuit 8100 with a processor 8120 and a memory 8140. The processor 8120 may be coupled to the memory 8140. The processor 8120 may be a general purpose or specific purpose processor, an application specific integrated circuit (ASIC), one or more field programmable gate arrays (FPGAs), a group of processing components, or other suitable processing components. The processor 8120 is configured to execute computer code or instructions stored in the memory 8140 or received from other computer readable media (e.g., CDROM, network storage, a remote server, etc.).

The memory 8140 may include one or more devices (e.g., memory units, memory devices, storage devices, etc.) for storing data and/or computer code for completing and/or facilitating the various processes described in the present disclosure. The memory 8140 may include random access memory (RAM), read-only memory (ROM), hard drive storage, temporary storage, non-volatile memory, flash memory, optical memory, or any other suitable memory for storing software objects and/or computer instructions. The memory 7140 may include database components, object code components, script components, or any other type of information structure for supporting the various activities and information structures described in the present disclosure. The memory 8140 may be communicably connected to the processor 8120 via the processing circuit 8100 and may include computer code for executing (e.g., by the processor 8120) one or more of the processes described herein.

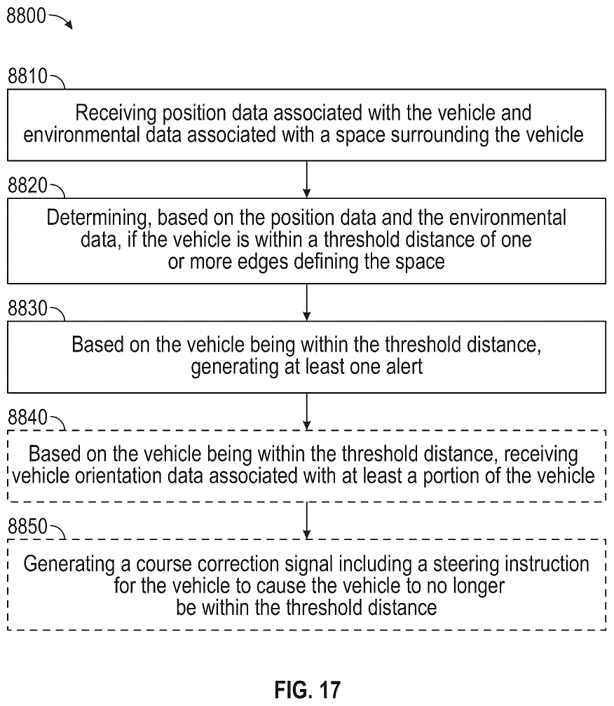

The memory 8140 includes instructions that when executed by the processor 8120 cause the processor 8120 to perform one or more processes. For example, the memory 8140 may include instructions for executing a method such as the method 8800 shown in FIG. 17. The instructions may cause the processor 8120 to receive position data associated with the vehicle 10 and environmental data associated with the space surrounding the vehicle 10. The position data and the environmental data define sensor data. In some embodiments, position data and/or the environmental data are received from the sensor assembly 8200. In some embodiments, the sensor data may be received periodically, sporadically, or continuously. In some embodiments, the sensor data may be received in response to a user input, a detected parameter, and/or the like. In some embodiments, a user may monitor the sensor data in real time. For example, a user operating (e.g., managing loading operations) the vehicle 10 may view (e.g., on a display, etc.) the sensor data, which may aid the user in operating the vehicle 10 into a desired configuration. In some embodiments, the user may confirm that the position of the sensors 8210 is desired. For example, the user may confirm that the coverage of the sensors 8210 is as desired. In some embodiments, the position data and/or the environmental data may include data (e.g., imaging data) associated with markers (e.g., fiducial markers, positioning markers, etc.) associated with the vehicle and/or the space. Based on the size, location, position, and/or the like of the markers, the position, location, and orientation of the vehicle and/or the space may be determined.

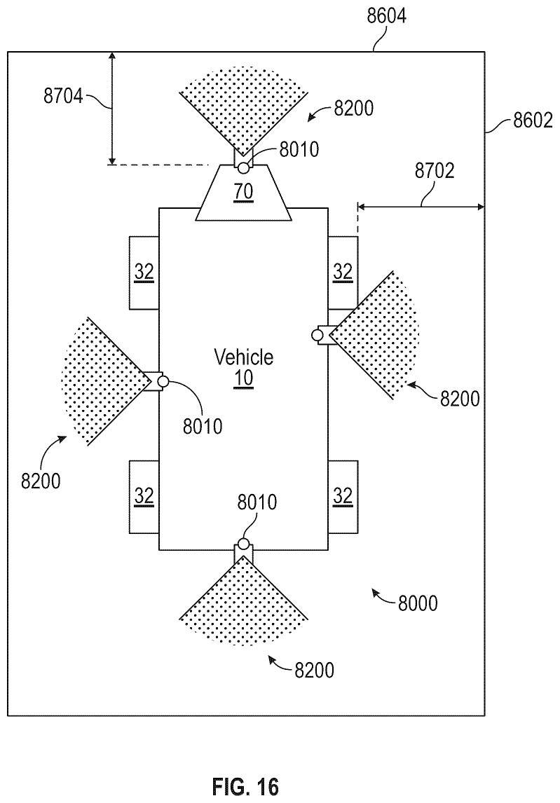

The instructions may cause the processor 8120 to determine, based on the sensor data, if the vehicle 10 is within a threshold distance in relation to the space. For example, the threshold distance may be a distance between one or more portions of the vehicle and a obstacles (e.g., surface, edge, etc.) defined by the space such as a wall, platform edge, and/or the like. The threshold distance is a predetermined distance that, during operation, is a safe operating distance from the obstacles. In some embodiments, the threshold distance may be different based on the portion of the vehicle 10. For example, the threshold distance may different for the wheel 32 and for the implement 70. The distance may be determined (e.g., calculated, measured, etc.) based on a position of one or more portion of the vehicle 10 in relation to the one or more obstacles. The distance may be a minimum distance. For example, the distance may correspond to the distance between a point of the vehicle 10 that is closest to the obstacles in the space. In some embodiments, multiple distances may be determined corresponding to various portions of the vehicle 10. For example, distances may be determined for each wheel 32, for an implement 70, and/or any portion of the vehicle 10 that extends away from the main body. As shown in FIG. 16, for example, a first distance 8702 may be determined between the wheel 32 and a first portion 8602 of the space around the vehicle 10. The first portion 8602 correspond to a sidewall of a shipping container, the edge of a flatbed truck, and/or the like. A second distance 8704 may also be determined between the implement 70 and the second portion 8604 of the space. Similar to the first portion 8062, the second portion 8604 may correspond to a sidewall of a shipping container, the edge of a flatbed truck, and/or the like. While not shown, additional distances may be determined between the vehicle 10 and the space.

After the distance is determined, the distance is compared to the threshold distance. If the distance is equal to or greater than the threshold distance, operation of the vehicle 10 is considered desirable (e.g., safe). If the distance is less than the threshold distance, at least one alert is generated. The at least one alert may include sending a signal to the vehicle 10, to a user, and/or the like. In some implementations, the at least one alert may include a display signal, a command, information, and/or the like. For example, the at least one alert may include a signal to generate warning to display on a user device (such as user devices 102), may cause vehicle 10 operation to be stopped, may cause vehicle information to be sent to the user device, and/or the like. The at least one alert may allow for an operator to alter or adjust the position of the vehicle 10 so that the vehicle is in a desired position. In some embodiments, the alert includes vehicle information such as vehicle orientation, vehicle position, and/or the like. In some embodiments, the direction of the vehicle 10 may be determined based on vehicle orientation data such as a position of the wheels 32. For example, if the direction of the vehicle 10 will decrease the distance below the threshold distance, an alert may be generated.

In some embodiments, the instructions may cause the processor 8120 to receive vehicle orientation data based on the vehicle being within the threshold distance. The vehicle orientation data is associated with at least a portion of the vehicle. For example, the vehicle orientation data may include wheel 32 position, positioning data, and/or the like. The vehicle orientation data may be used to generate a course correction signal. The course correction signal may include steering instructions for the vehicle 10, that when executed, cause the vehicle 10 to no longer be within the threshold distance. The steering instructions may be sent to the vehicle 10 and/or the user, via a user device, such as the user devices 102. In some embodiments, the steering instructions may be executed, by a controller, such as the controller 52, automatically by the vehicle 10, or manually by the operator.

Referring to FIG. 17, a method 8800 of loading a vehicle within a space is shown. The space may include a loading dock, a shipping container, a platform, and/or the like. The method 8800 may be executed by the user device (e.g., user devices 102), a controller (e.g., the controller 52), a vehicle (e.g., vehicle 10, telehandler 7010), and/or the like. The method 8800 may be used with a vehicle loading system, such as the vehicle loading system 8000 described herein. The method 8800 reduces or prevent damage to a vehicle during loading by reducing the likelihood that the vehicle contacts a portions of the space. The method 8800 may operate continuously during the loading process or may be activated by a user and/or automatically when desired.

In 8810, the method 8800 includes receiving position data associated with the vehicle and environmental data associated with a space surrounding the vehicle. The position data and environmental data may be received from one or more sensor mounted to the vehicle. The sensors may be any sensor configured sense the location, position, and/or orientation of the vehicle and/or the space. In some embodiments, the sensors may be configured to sense the location, position, and/or orientation of one or more markers (e.g., positioning markers, fiducial markers, etc.) of the vehicle and/or the space. In some embodiments, the one or more markers may be used to determine the location, position, and/or orientation of the vehicle and/or the space.

In 8820, the method 8800 includes determining, based on the position data and the environmental data, if the vehicle is withing a threshold distance of one or more edges defining the space. The threshold distance corresponds to a desired (e.g., safe) operating distance associated with the vehicle in the space. In some embodiments, the threshold distance may be different for different portions of the vehicle. Determining if the vehicle is within the threshold distance may include determining one or more distances between portions of the vehicle and obstacles (e.g., walls, features, edges, etc.) of the space.

In 8830, the method 8800 includes generating at least one alert, based on the vehicle being within the threshold distance. The at least one alert may indicate that the vehicle is an undesired position and correction is desired. The at least one alert may include instructions and/or information associated with the vehicle and/or the space. In some embodiments, the at least one alert may be sent to the vehicle and/or a user device. In some embodiments, the at least one alert may cause the operation of the vehicle to cease or pause so that vehicle may be returned to a desired position.

In 8840, the method 8800 optionally includes receiving vehicle orientation data associated with the at least a portion of the vehicle based on the vehicle being within the threshold distance. The vehicle orientation data may include a vehicle position, configuration, and/or the like. In some embodiments, the vehicle orientation data may include wheel position data and/or position of other portions of the vehicle. In some embodiments, the vehicle orientation data is sent automatically or based on a input from a user. In 8850, the method 8800 optionally includes generating a course correction signal including a steering instruction for the vehicle to cause the vehicle to no longer be within the threshold distance. The steering instructions can include instructions that allow for the vehicle to return without damaging the vehicle in the space. The steering instructions can be sent to a user device or the vehicle. The steering instructions can be executed automatically (e.g., by the vehicle) or can be executed by the user manually. Once the vehicle is back in a desired position (e.g., outside of the threshold distance), the method 8800 can restart from 8810 so that the position of the vehicle can be constantly monitored during loading, allowing for improved safety during loading. The method 8800 can be exited manually and/or automatically once the vehicle is in the desired configuration for shipping.

### Image Recognition

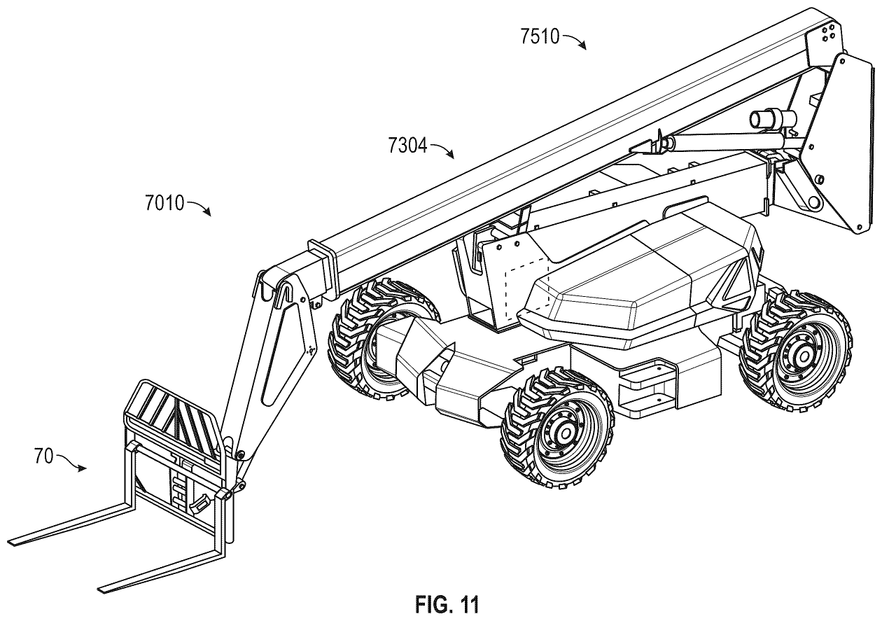

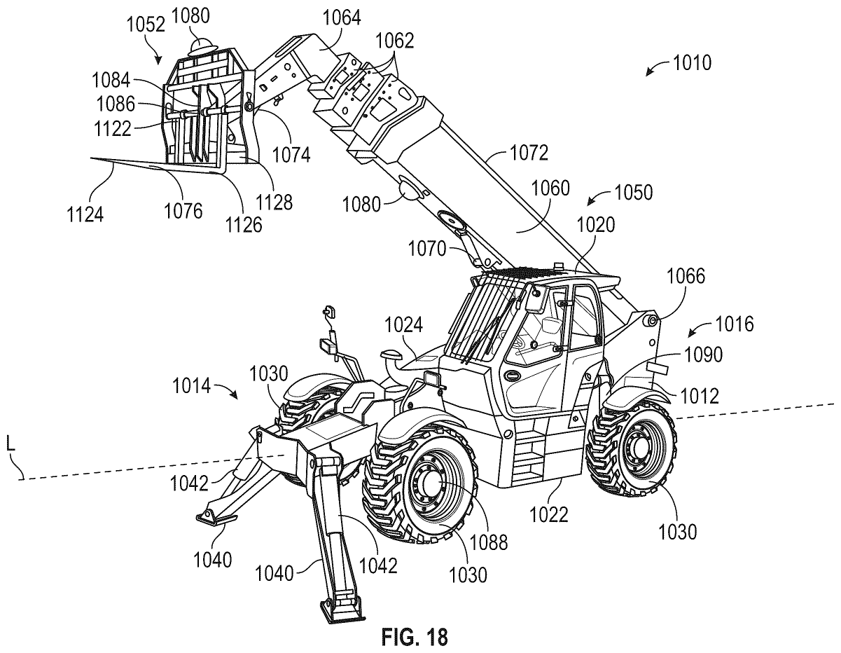

Referring to FIG. 18-21 a vehicle or work machine (e.g., a lift device) is shown as telehandler 1010 according to an exemplary embodiment. In other embodiments, the telehandler 1010 is another type of lift device, such as a boom lift, an aerial work platform, a scissor lift, a vertical lift, a compact crawler boom, a forklift, a crane, a bucket truck, or another type of lift device. In yet other embodiments, the telehandler 1010 is another type of vehicle or work machine, such as a military vehicle, a cement truck, a refuse vehicle, a fire apparatus (e.g., a fire truck including a deployable ladder, an aircraft rescue and firefighting truck, etc.), a tow truck, or another type of vehicle or work machine. In some implementations, the telehandler 1010 is the vehicle 10, as described with reference to FIG. 1-17.

Referring generally to the Figures, described herein are exemplary embodiments of systems and methods for image recognition for fork alignment of a work machine. The work machine may use cameras to determine a position of a fork pocket of a storage container. The work machine may use sensors to determine a position of a lift fork of the work machine. The work machine may compare the position of the fork pocket to the position of the lift fork. The work machine may determine a desired operation of one or more actuators of the work machine to align the lift fork and the fork pocket and/or determine a desired operation of a primary driver to align the lift fork and the fork pocket.

The desired operation may include automatic operation of the actuators and/or primary driver to align the lift fork and the fork pocket. The desired operation may include providing an instruction via a user interface for an operator of the work machine to operate the actuators and/or primary driver to align the lift fork and the fork pocket. The desired operation may include an automatic operation of the actuators and/or primary driver to insert the lift fork into the fork pocket. The desired operation may include an instruction for the operator of the work machine to insert the lift fork into the fork pocket.

### Telehandler

As shown in FIG. 18-20, the telehandler 1010 includes a chassis, shown as frame assembly 1012, having a front end 1014 and a rear end 1016. The frame assembly 1012 supports an enclosure, shown as cabin 1020, that is configured to house an operator of the telehandler 1010. The telehandler 1010 is supported by a plurality of tractive elements 1030 that are rotatably coupled to the frame assembly 1012. As shown, the tractive elements 1030 include a pair of front wheels (e.g., supported on a front axle) positioned proximate the front end 1014 and a pair of rear wheels (e.g., supported on a rear axle) positioned proximate the rear end 1016. One or more of the tractive elements 1030 may be powered (e.g., driven by the primary driver 1032) to facilitate motion of the telehandler 1010.

The frame assembly 1012 defines a longitudinal axis, shown as longitudinal centerline L, that extends along the length of the frame assembly 1012. The cabin 1020 is laterally offset from the longitudinal centerline L. The cabin 1020 includes a door 1022 configured to facilitate selective access into the cabin 1020. The door 1022 may be located on the lateral side of the cabin 1020 opposite the lift assembly 1050. An enclosure, shown as housing 1024, is coupled to the frame assembly 1012. The housing 1024 is laterally offset from the longitudinal centerline L in a direction opposite the cabin 1020. The housing 1024 contains various components of the telehandler 1010 (e.g., the primary driver 1032, the pump 1034, a fuel tank, a hydraulic fluid reservoir, etc.). The housing 1024 may include one or more doors to facilitate access to components of the telehandler 1010.

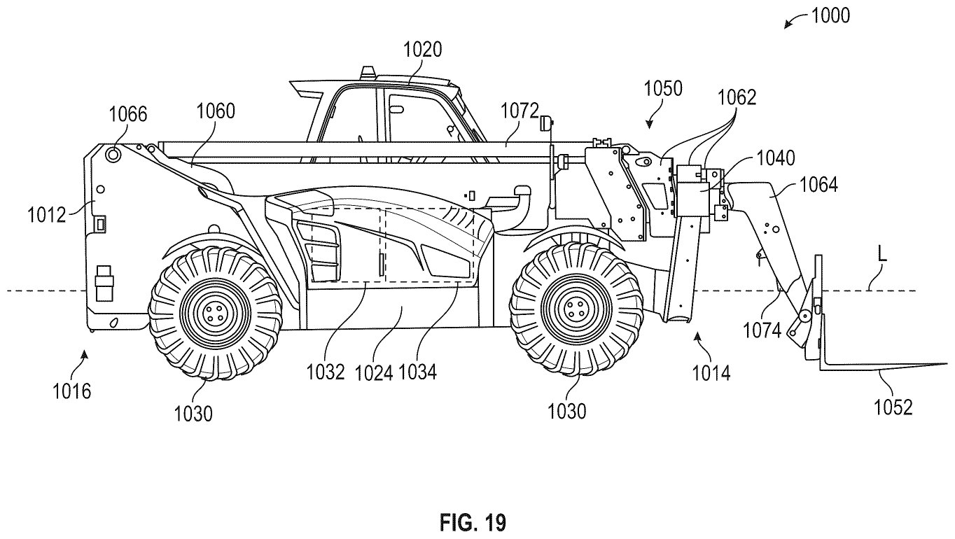

Each of the tractive elements 1030 may be powered or unpowered. Referring to FIG. 19, the telehandler 1010 includes a powertrain system including a primary driver, shown as primary driver 1032. The primary driver 1032 may receive fuel (e.g., gasoline, diesel, natural gas, etc.) from a fuel tank and combust the fuel to generate mechanical energy. According to an exemplary embodiment, the primary driver 1032 is a compression-ignition internal combustion primary driver that utilizes diesel fuel. In some embodiments, the primary driver 1032 is another type of device (e.g., spark-ignition engine, fuel cell, etc.) that is otherwise powered (e.g., with gasoline, compressed natural gas, hydrogen, etc.). In some embodiments, the primary driver 1032 is a battery powered electric motor.

As shown in FIG. 19, a hydraulic pump, shown as pump 1034, receives the mechanical energy from the primary driver 1032 and provides pressurized hydraulic fluid to power the tractive elements 1030 and the other hydraulic components of the telehandler 1010 (e.g., the outrigger actuators 1042, the lift actuator 1070, the extension actuator 1072, the level actuator 1074, the fork elevation actuator 1084, the fork separation actuator 1086 etc.). The pump 1034 may provide a pressurized flow of hydraulic fluid to individual motive drivers (e.g., hydraulic motors) configured to facilitate independently driving each of the tractive elements 1030 (e.g., in a hydrostatic transmission configuration). In such embodiments, the telehandler 1010 also includes other components to facilitate use of a hydraulic system (e.g., reservoirs, accumulators, hydraulic lines, valves, flow control components, etc.). In other embodiments, the primary driver 1032 provides mechanical energy to the tractive elements 1030 through another type of transmission. In yet other embodiments, the telehandler 1010 includes an energy storage device (e.g., a battery, capacitors, ultra-capacitors, etc.) and/or is electrically coupled to an outside source of electrical energy (e.g., a standard power outlet coupled to the power grid). In some such embodiments, one or more of the tractive elements 1030 include an individual motive driver (e.g., a motor that is electrically coupled to the energy storage device, etc.) configured to facilitate independently driving each of tractive elements 1030. The outside source of electrical energy may charge the energy storage device or power the motive drivers directly.

Referring to FIG. 18, the telehandler 1010 includes a pair of supports, shown as outriggers 1040. The outriggers 1040 are selectively repositionable between a stored position (e.g., as shown in FIG. 19) and a deployed position (e.g., as shown in FIG. 18). Each outrigger includes a corresponding actuator (e.g., a hydraulic cylinder), shown as outrigger actuator 1042, that moves the outriggers 1040 between the stored position and the deployed position. As shown, the outriggers 1040 are pivotably coupled to the frame assembly 1012. In other embodiments, the outriggers 1040 are slidably coupled to the frame assembly 1012. In the stored position, the outriggers 1040 are raised above the ground to facilitate free motion of the telehandler 1010. In the deployed position, the outriggers 1040 contact the ground, supporting a portion of the weight of the telehandler 1010. The outriggers 1040 increase the overall size of the footprint of the telehandler 1010 that contacts the ground, further increasing the tip resistance (e.g., stability) of the telehandler 1010. As shown in FIG. 18, the outriggers 1040 are configured to raise the front end 1014 off the ground. In other embodiments, another set of outriggers 1040 lift the rear end 1016 alternately or in addition to the front end 1014.

The telehandler 1010 includes a lift assembly, shown as lift assembly 1050, having a proximal end that is pivotably coupled to the frame assembly 1012 near the rear end 1016. A distal end of the lift assembly 1050 supports a tool or manipulator, shown as lift fork assembly 1052. The lift fork assembly 1052 may be any type of mechanism used to support, grab, or otherwise interact with a storage container. The lift fork assembly 1052 may include one or more of a base and/or a lift fork 1076 (e.g., pallet forks, bale forks, etc.), a bucket, a grapple or grab (e.g., a bale grab, a log grab, a shear grab, a grab for use in combination with a bucket, etc.), a boom (e.g., a boom supporting a cable used to manipulate roof trusses), an auger, a concrete bucket, and another type of implement. The lift fork 1076 may be configured to insert into a fork pocket of the storage container.

The telehandler 1010 may permit an operator to control the tractive elements 1030 and the lift assembly 1050 from within the cabin 1020 to manipulate (e.g., move, carry, lift, transfer, etc.) the storage container (e.g., pallets, building materials, earth, grain, etc.). The telehandler 1010 may include one or more camera(s) 1080 (e.g., video devices) disposed on the lift assembly 1050 and/or the lift fork assembly 1052. The camera 1080 may be configured to view the lift fork 1076 in relation to the storage container. For example, the camera 1080 may be configured to view that the lift fork assembly 1052 is a certain distance, orientation, and/or elevation from the storage container. The camera 1080 may be configured to convert images into digital image data. The camera 1080 may be configured to transmit the digital image data to a controller of the telehandler 1010 via wired connection and/or wireless connection.

The telehandler 1010 may include one or more elevation sensors 1126 configured to detect an elevation of the lift fork 1076. For example, the elevation sensors 1126 may detect the elevation of the lift fork 1076 relative to the ground. The elevation sensor may be an optical imaging sensor, an ultrasonic sensor, a laser rangefinder, and/or a lidar sensor. The elevation sensor 1126 may be configured to transmit the elevation detections to the sensor system 1130. The number of elevation sensors 1126 may be based on a number of lift forks 1076 of the lift fork assembly 1052. For example, a lift fork assembly 1052 may have a plurality of lift forks 1076, and each lift fork 1076 may have an individual elevation sensor 1126 to detect elevation independently of the other lift forks 1076.

The telehandler 1010 may include one or more level sensors 1122 configured to detect the level of the lift fork 1076. For example, the level sensors 1122 may detect that the lift fork 1076 is parallel to the longitudinal centerline L. The level sensor 1122 may be an inclinometer, a rotary encoder, a potentiometer, a digital angle sensor, and/or other level sensors. The number of level sensors 1122 may be based on a number of lift forks 1076 of the lift fork assembly 1052. For example, a lift fork assembly 1052 may have a plurality of lift forks 1076, and each lift fork 1076 may have an individual level sensor 1122 to detect level independently of the other lift forks 1076.

The telehandler 1010 may include one or more fork separation sensors 1124 configured to detect a separation (e.g., separation, space) between a first lift fork 1076 and a second lift fork 1076 of the lift fork assembly 1052. For example, a lift fork assembly 1052 including two lift forks 1076 may be separated by a variable distance, and the fork separation sensor 1124 may be configured to detect the separation. The fork separation sensor may be an ultrasonic sensor, laser distance sensor, photoelectric sensors, and/or other proximity sensors. The number of fork separation sensors 1124 may be based on a number of lift forks 1076 of the lift fork assembly 1052. For example, a lift fork assembly 1052 may have two lift forks 1076, and the lift fork assembly 1052 may include one fork separation sensor 1124 to detect the separation between the forks. As another example, a lift fork assembly 1052 may have three lift forks 1076, and the lift fork assembly 1052 may include two fork separation sensor 1124 to detect the separation between the first lift fork 1076 and second lift fork 1076, and the separation between the second lift fork 1076 and the third lift fork 1076. In some embodiments, the separation distance is inferred by the positions of the one or more actuators controlling the two lift forks 1076.

The telehandler 1010 may include one or more distance sensors 1128 to detect the distance (e.g., separation, space) between the lift fork 1076 and a fork pocket of storage containers along the longitudinal centerline L. The distance sensor 1128 may be an ultrasonic sensor, an infrared distance sensor, a laser distance sensor, and/or other proximity sensor. The distance sensor 1128 may serve to detect a distance between the lift fork 1076 and the fork pocket when the camera 1080 is not in view of the fork pocket. This may facilitate manual operation of the work machine to reduce the distance between the fork pocket and the lift fork 1076 such that the camera 1080 can view the fork pocket.

The lift assembly 1050 is approximately centered on the longitudinal centerline L to facilitate an even weight distribution between the left and the right sides of the telehandler 1010. In one embodiment, the longitudinal centerline and a centerline of the lift assembly 1050 are disposed within a common plane (e.g., when the lift assembly 1050 is stowed, during movement of the lift assembly 1050, etc.).

Referring to FIG. 18-20, the lift assembly 1050 is a telescoping assembly including a series of boom sections that translate relative to one another to vary an overall length of the lift assembly 1050. The lift assembly 1050 includes a base boom section or base boom 1060, one or more middle boom sections or middle booms 1062, and a distal boom section or fly boom section shown as fly boom 1064. The base boom 1060 is pivotally coupled to the frame assembly 1012 and pivotable relative to the frame assembly 1012 about a lateral axis, shown as axis of rotation 1066. The axis of rotation 1066 is positioned near the rear end 1016. The middle booms 1062 are received within the base boom 1060 and slidable relative to the base boom 1060. In embodiments where the lift assembly 1050 includes multiple middle booms 1062, the middle booms are slidably received within one another. The fly boom 1064 is received within most distal of the middle booms 1062 and slidable relative to the middle booms 1062.

Referring to FIG. 18-20, the lift assembly 1050 and the lift fork assembly 1052 are articulated by a series of actuators, including a first actuator, shown as lift actuator 1070, a second actuator, shown as extension actuator 1072, a third actuator, shown as level actuator 1074, a fourth actuator, shown as fork elevation actuator 1084, a fifth actuator, shown as fork separation actuator 1086. The actuators are configured to control the lift assembly 1050 and/or the lift fork assembly 1052 to lift or otherwise manipulate various loads. As shown in FIG. 18-20, the actuators may be hydraulic cylinders powered by pressurized fluid from the pump 1034 that extend and retract linearly. In such embodiments, the hydraulic cylinders each include a body that defines an interior volume and receives a shaft. A piston is connected to the shaft and engages an interior surface of the body, dividing the interior volume of the body into a pair of chambers. Pressurized hydraulic fluid is selectively pumped (e.g., by pump 1034) into each of the chambers to selectively expand or contract the hydraulic cylinder. The hydraulic cylinders may include bosses, clevises, or other features to facilitate interfacing with other components (e.g., the frame assembly 1012, the boom sections, etc.). In other embodiments, the actuators are another type of linear actuator (e.g., electrical, pneumatic, etc.) or are rotary actuators.

The lift actuator 1070 is coupled to the frame assembly 1012 and the base boom 1060. In some embodiments, the lift actuator 1070 is configured to raise and/or lower the lift assembly 1050 by rotating the base boom 1060 about the axis of rotation 1066. This may facilitate the motion of the lift assembly 1050 vertically and/or horizontally (e.g. along the longitudinal centerline L). The extension actuator 1072 is coupled to the base boom 1060 and one of the other boom sections (e.g., the fly boom 1064, a middle boom 1062, etc.). The extension actuator 1072 is configured to vary the length of the lift assembly 1050 by causing the middle booms 1062 and the fly boom 1064 to translate relative to the base boom 1060.

The level actuator 1074 is coupled to the lift fork 1076 and the base of the lift fork assembly 1052. The level actuator 1074 is configured to reposition (e.g., pivot, angle) an orientation of the lift fork 1076 relative to the base of the lift fork assembly 1052. The level actuator 1074 may facilitate the alignment of the lift fork to a storage container that is on an uneven (e.g., angled, tilted) surface. For example, if the storage container is placed on an inclined plane, the level actuator may adjust the angle of the lift fork 1076 to match the angle of the storage container. The fork elevation actuator 1084 is coupled to the lift fork assembly 1052 and the lift fork 1076. In some embodiments, the number of fork elevation actuators 1084 may vary based on the number of lift forks 1076. For example, the number of fork elevation actuators 1084 may be equal to the number of lift forks 1076. The fork elevation actuator 1084 is configured to adjust (e.g., raise or lower) the lift fork 1076 relative to the base of the lift fork assembly 1052. For example, the fork elevation actuator 1084 may be configured to raise/lower the lift fork 1076 without adjusting the position of the lift assembly. This may facilitate the fine tuning (e.g., small adjustments, precision adjustments) of the position of the lift fork 1076.

The fork separation actuator 1086 is coupled to the lift fork assembly 1052 and the lift fork 1076. The telehandler 1010 may include the fork separation actuator 1086 when the lift fork assembly 1052 includes more than one lift fork 1076. The fork separation actuator 1086 may adjust (e.g., translate) a first lift fork 1076 relative to a second lift fork 1076. The fork separation actuator 1086 may adjust the position of the first lift fork 1076 and/or the second lift fork 1076 such that a distance (e.g., lateral distance) between the first lift fork 1076 and the second lift fork 1076 increases or decreases. The fork separation actuator 1086 may be configured to adjust (e.g., translate) the first lift fork 1076 and the second lift fork 1076 simultaneously, thereby maintaining the center of mass of the lift fork assembly 1052 in the center of the lift fork assembly 1052. Adjusting the distance between the first lift fork 1076 and the second lift fork may allow for interaction with storage containers that include fork pockets of variable distance.

The steering actuator 1088 is coupled to the tractive elements 1030 and the frame assembly 1012. The steering actuator 1088 is configured to adjust the position of the tractive elements 1030 relative to the longitudinal centerline L. For example, the steering actuator 1088 may be configured to adjust the tractive elements from a position parallel to the longitudinal centerline L to a position not parallel to the longitudinal centerline L. This may allow for adjustments to the tractive elements 1030 such that when the primary driver 1032 is operated, the telehandler 1010 may move such that the longitudinal centerline L is repositioned. The steering actuator 1088 may be a single steering actuator 1088 configured to reposition all of the tractive elements 1030, or multiple steering actuators 1088 configured to reposition some of the tractive elements 1030 independently.

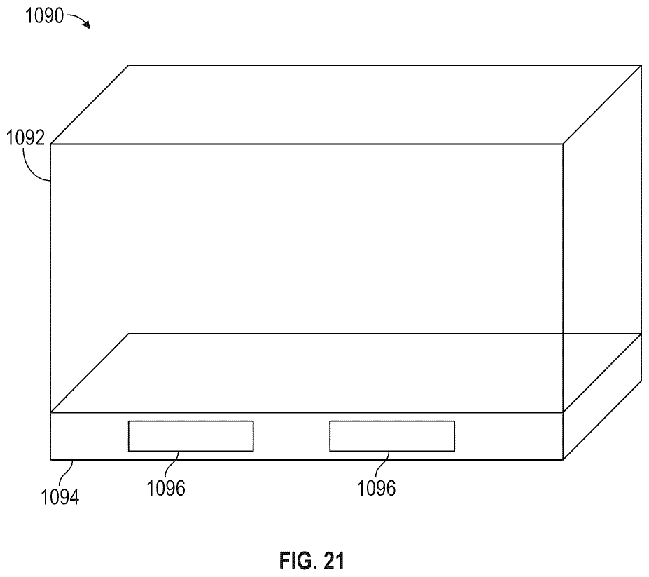

Referring to FIG. 21, depicted is a storage container 1090, according to an exemplary embodiment. The storage container 1090 may be a pallet, a bucket, a dumpster, or a different container configured to be lifted by the telehandler 1010. Storage container 1090 may include a storage compartment 1092. The storage compartment 1092 may be configured to hold items while being moved by the telehandler 1010. The storage compartment 1092 may include a rigid enclosure (e.g., wood, metal, hard plastic) or a soft enclosure (e.g., plastic wrap, cardboard). The storage container 1090 may include a fork interface 1094, which is separate from the storage compartment 1092. In some embodiments, the fork interface 1094 is disposed in an area underneath the storage compartment 1092. In some embodiments, the fork interface 1094 is disposed in an area on the left and/or right sides of the storage compartment 1092. The fork interface 1094 may be made of a rigid material that will not bend or break when the storage container 1090 is being lifted. The fork interface 1094 may include one or more fork pockets 1096. The fork pockets 1096 may be openings in the fork interface configured to house the lift forks 1076. The fork pockets 1096 may be sized based on the dimensions of the lift forks 1076, to facilitate easy insertion and/or removal of the lift forks 1076 from the fork pockets 1096.

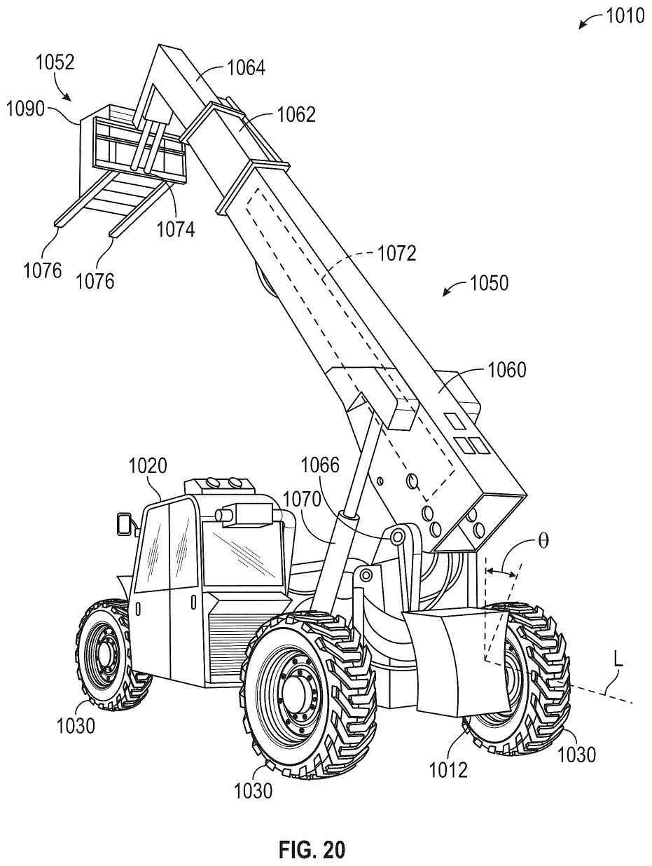

Referring to FIGS. 20 and 21, FIG. 20 depicts the telehandler 1010 interacting with the storage container 1090, according to an exemplary embodiment. The lift forks 1076 are fully inserted into the fork pockets 1096, such that the storage container 1090 rests against the body of the lift fork assembly 1052. This configuration may allow for secure lifting and transporting of the storage container 1090 by the telehandler. The level actuator 1074 may tilt the lift forks 1076, causing the lift forks 1076 to be angled slightly upward relative to the body of the lift fork assembly 1052, such that the gravitational force exerted upon the storage container is directed into the lift fork assembly 1052. This configuration may allow for an additional level of stability when lifting and moving the storage container 1090.

### Image Recognition for Fork Alignment

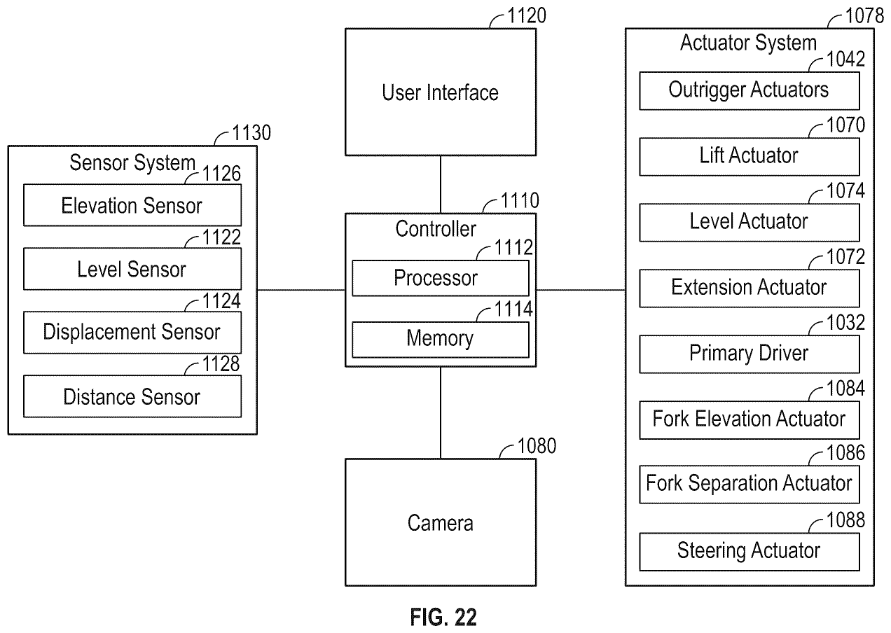

Referring to FIG. 22, depicted is a system for using image recognition to achieve fork alignment of a work machine (e.g., work machine device, work machine system), according to an exemplary embodiment. In some embodiments, the work machine is the telehandler 1010. In some embodiments, the work machine is a different vehicle incorporating at least some elements of the telehandler 1010 such as a military vehicle, a cement truck, a refuse vehicle, a fire apparatus (e.g., a fire truck including a deployable ladder, an aircraft rescue and firefighting truck, etc.), a tow truck, or another type of vehicle or work machine.

The work machine may include an actuator system 1078. The actuator system 1078 may include actuators of the telehandler 1010, such as the outrigger actuators 1042, the lift actuator 1070, the level actuator 1074, the extension actuator 1072, the primary driver 1032, the fork elevation actuator 1084, the fork separation actuator 1086, and/or the steering actuator 1088, among other actuators. The work machine may include a sensor system 1130. The sensor system 1130 may include sensors of the telehandler 1010, such as the elevation sensor 1126, the level sensor 1122, the fork separation sensor 1124, and/or the distance sensor 1128, among other sensors. The work machine may include the camera 1080 of the telehandler 1010. The work machine may include the user interface 1120 of the telehandler 1010. Communications between the actuator system 1078, sensor system 1130, camera 1080, and user interface 1120 may be facilitated or otherwise controlled by a controller 1110.

The controller 1110 may include one or more processors 1112 (e.g., processing circuits, processing circuitry, etc.) coupled with memory 1114. The memory may include computer readable instructions that, when executed by the processors, facilitates communication between the actuator system 1078, the sensor system 1130, camera 1080, and/or the user interface 1120. Additionally, or alternatively, the controller 1110 may transmit instructions to the actuator system 1078, sensor system 1130, camera 1080, and/or user interface 1120. For example, the controller may transmit an instruction to the sensor system 1130 to detect the elevation of the lift forks 1076. As another example, the controller 1110 may transmit an instruction to the actuator system 1078 to adjust the elevation of the lift forks 1076. As another example, the controller 1110 may transmit an instruction to the camera 1080 to transmit image data. The processors 1112 may process sensor data from the sensor system 1130 and/or image data from the camera 1080, and/or control the actuator system 1078 based on the sensor data and/or image data. The actuator system 1078 may include a computer or other electronic device to communicatively couple with the controller 1110. The actuator system 1078 may include one or more actuators configured to operate (e.g., control, move, adjust, etc.) components of the work machine. The actuator system 1078 may receive instructions from the controller 1110, and operate the actuators according to the instructions. For example, the actuator system 1078 may receive an instruction from the controller 1110 to adjust the elevation of the lift forks 1076, and the actuator system may operate an actuator of the actuator system 1078 to adjust the elevation of the lift forks 1076.

The sensor system 1130 may include a computer or other electronic device to communicate with the controller 1110. The sensor system 1130 may include one or more sensors configured to detect information associated with the lift fork assembly 1052. For example, the sensors may determine a distance between a first lift fork 1076 and a second lift fork 1076 of the lift fork assembly 1052. The sensor system 1130 may receive instructions from the controller 1110, and facilitate operation of the sensors according to the instructions. For example, the sensor system 1130 may receive an instruction from the controller to determine the distance between a first lift fork 1076 and a second lift fork 1076, and the sensor system 1130 may operate the sensors accordingly.

The camera 1080 may include a video device capable of taking still images and/or digital video. The camera 1080 may include a computer or other electronic device to communicate with the controller 1110. The camera 1080 may include a streaming and/or data transfer protocol to transmit image data to the controller 1110. The camera 1080 may be capable of transmitting image data in real time to the controller 1110 such that the controller receives a live video feed from the camera 1080. The camera 1080 may be capable of receiving instructions from the controller 1110 regarding operations of the camera. For example, the camera 1080 may receive an instruction to transmit live video feed to the controller 1110.

The user interface may facilitate interaction between a user (e.g., operator) and the controller 1110. The user interface 1120 may be a graphical user interface (GUI). The user interface 1120 may include a display (e.g., monitor, touch screen) configured to present the user information relating to the work machine. For example, the user interface 1120 may display the image data from the camera 1080. The user interface 1120 may include one or more selectable elements to indicate user inputs and/or preferences regarding operations of the work machine. For example, the user interface 1120 may include a selectable element configured to operate an actuator of the actuator system 1078, responsive to user interaction with the selectable element.

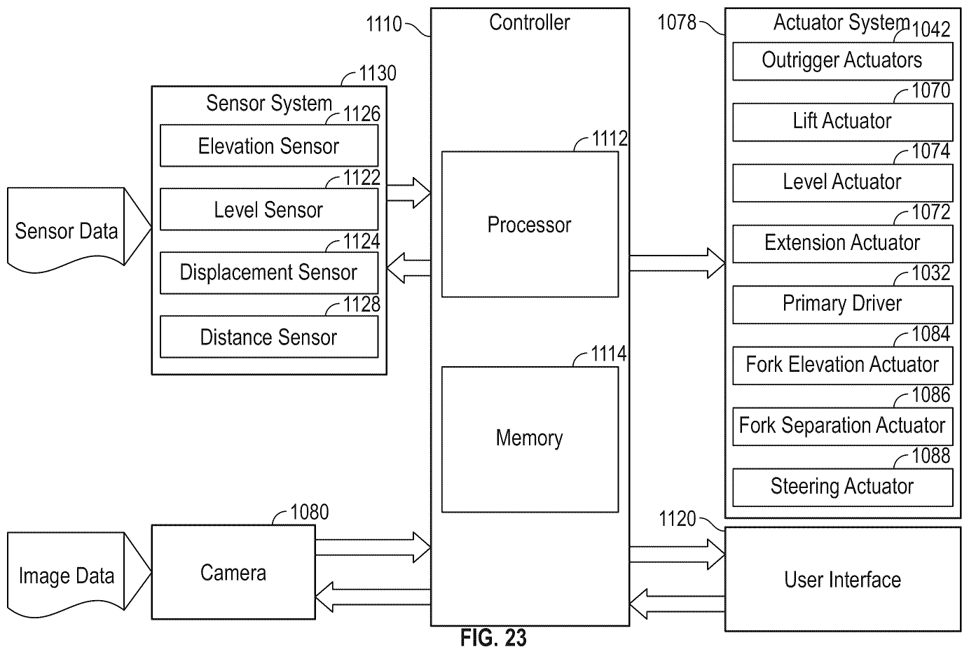

Referring to FIG. 23, depicted is a communication system 600 for using image recognition to achieve fork alignment of a work machine, according to an exemplary embodiment. In some embodiments, an instruction is transmitted from the user interface 1120 to the controller 1110 including a request for alignment. The request may indicate that the work machine should align the lift fork to the fork pockets 1096. The instruction may be transmitted via a wired transmission (e.g., ethernet) or a wireless transmission (Wi-Fi, Bluetooth). The instruction may be transmitted responsive to a user interacting with a selectable element of the user interface 1120.

Upon receiving the instruction, the controller 1110 may transmit an instruction to the camera 1080. The instruction may include a request for image data from the camera 1080. The instruction may indicate a type of image data requested (e.g., still photograph, live video feed, recorded video feed). In some embodiments, the camera 1080 begins recording responsive to receipt of the request. The camera 1080 may convert the recorded feed into digital image data, and transmit the data to the controller 1110. The controller 1110 may process the image data, and, based on the image data, determine or otherwise identify a position of the fork pockets 1096 of the storage container 1090. The controller 1110 may process the image data and determine an angle of the storage container 1090, relative to the longitudinal centerline L. The controller may determine the position of the fork pockets 1096 using any of artificial intelligence models (e.g., machine learning, neural networks), template matching, or edge detection, among other methods.

In some embodiments, at the time of recording, the camera 1080 is not in view of the fork pockets 1096. For example, the camera 1080 may be positioned too low to view the fork pockets 1096. In these cases, the controller 1110 may transmit an instruction to the user interface 1120 to display a message indicating that the user should reposition the work machine to place the camera 1080 in view of the fork pockets 1096. The message may include a live stream of the camera 1080, so that the user can see the current view of the camera. This may guide the user while repositioning the work machine.

The controller 1110 may transmit an instruction to the sensor system 1130. The instruction may include a request for sensor data. The sensor data may include sensor readings from any of the elevation sensor 1126, the level sensor 1122, the fork separation sensor 1124, and the distance sensor 1128, among other sensors of the sensor system 1130. The sensor system 1130 may transmit the sensor data to the controller 1110. The controller may process the sensor data to determine a position of the lift forks 1076 of the lift fork assembly 1052. The position of the lift forks 1076 may be based on determinations regarding an elevation of the lift forks 1076, an angle of the lift forks 1076 relative to the longitudinal centerline L, a separation between a first lift fork 1076 and a second lift fork 1076, and a distance between an end of the lift fork 1076 and the fork pocket 1096, along the longitudinal centerline L, among other features of the lift forks 1076. If the camera 1080 is not positioned to view the fork pockets 1096, the controller 1110 may transmit an instruction to the user interface 1120 to display a message indicating that the user should reposition the work machine to place the camera 1080 in view of the fork pockets 1096. The message may include sensor data to guide the user while repositioning. For example, the message may indicate a current elevation of the lift forks 1076 and/or a distance between the lift forks 1076 and the fork pockets 1096.

Upon determining the position of the lift forks 1076 and a position of the fork pockets 1096, the controller 1110 may determine a desired operation of the controller 1110 to align the lift forks 1076 and the fork pockets 1096. In some embodiments, the desired operation of the controller 1110 includes a hybrid mode of operation of the work machine. While in hybrid mode, the controller 1110 may instruct or otherwise direct the user to manually align the lift forks 1076 and the fork pockets 1096. For example, the controller 1110 may indicate to the user that the lift forks 1076 are not aligned to the fork pockets 1096, and instruct the user to operate one or more actuators of the actuator system 1078 to manually adjust the alignment of the lift forks 1076 until the alignment of the lift forks 1076 match the alignment of the fork pockets 1096. In some embodiments, once the alignments match, the controller 1110 is configured to indicate to the user to stop adjusting the actuator system 1078. In some embodiments, once the alignments match, the controller 1110 is configured to automatically stop operation of the actuator system 1078.

While in hybrid mode, the controller 1110 may instruct or otherwise direct the user to manually align the lift forks 1076 to the fork pockets 1096 by displaying instructions to the user interface 1120. For example, the controller 1110 may configure the user interface 1120 to display a message to the user indicating that the lift forks 1076 should be adjusted to be at a higher elevation. The controller 1110 may configure an alarm and/or light system of the cabin 1020 to alert the user regarding the alignment of the lift forks 1076. For example, when the lift forks 1076 and fork pockets 1096 are not aligned, the alarm may sound. When the lift forks 1076 and fork pockets 1096 are aligned, the alarm may turn off.

Upon determining the position of the lift forks 1076 and a position of the fork pockets 1096, the controller 1110 may determine a desired operation of the actuator system 1078 to automatically (e.g., autonomously) align the lift forks 1076 and the fork pockets 1096. In some embodiments, the desired operation of the actuator system 1078 includes matching an elevation of the lift fork 1076 to the elevation of the fork pocket 1096. The controller 1110 may determine the elevation of the lift fork 1076 based on sensor data of the elevation sensor 1126. The controller 1110 may determine the elevation of the fork pocket 1096 based on the image data of the camera 1080. The controller 1110 may compare the elevation of the lift fork 1076 to the elevation of the fork pocket 1096 and determine one or more actuators of the actuator system 1078 that may be operated to raise or lower the lift fork 1076 to match (or be within a predetermined threshold of) the elevation of the fork pocket 1096. For example, any of the lift actuator 1070, the extension actuator 1072, and/or the fork elevation actuator 1084 may be used to adjust the elevation of the lift fork 1076.

In some embodiments, adjusting the elevation of the lift fork includes operating one or more actuators of the lift assembly 1050. For example, the lift actuator 1070 may raise or lower the lift assembly 1050 by rotating the base boom 1060 about the axis of rotation 1066, causing an adjustment of the elevation of the lift fork 1076. As another example, the extension actuator 1072 may be operated to vary the length of the lift assembly 1050 by causing the middle booms 1062 and the fly boom 1064 to translate relative to the base boom 1060, causing an adjustment of the elevation of the lift fork 1076.

Adjusting the elevation of the lift fork may include operating one or more actuators of the lift fork assembly 1052. For example, the fork elevation actuator 1084 may be configured to raise and/or lower the lift fork 1076 relative to the base of the lift fork assembly 1052. Adjusting the elevation of the lift fork 1076 by operating the fork elevation actuator 1084 may serve to make smaller (e.g., more specific, more calculated, fine-tuned) adjustments than the actuators of the lift assembly 1050. Adjusting the elevation of the lift fork 1076 by operating the fork elevation actuator 1084 may serve to adjust individual lift forks 1076 without adjusting other lift forks 1076 of the lift fork assembly 1052. For example, if the lift fork assembly 1052 includes two lift forks 1076, the lift fork elevation actuator may adjust the elevation of each lift fork 1076 independently. This may enable alignment when the fork pockets 1096 are uneven (e.g., positioned at different elevations). For example, the fork pockets 1096 may be uneven when placed on a non-flat (e.g., tilted, uneven) surface.

The desired operation may include matching a separation of a first lift fork 1076 and a second lift fork 1076 to a separation of a first fork pocket 1096 and a second fork pocket 1096. The controller 1110 may determine the separation between the first lift fork 1076 and the second lift fork 1076 based on sensor data of the fork separation sensor 1124. The controller 1110 may determine the separation of the first fork pocket 1096 and the second fork pocket 1096 based on the image data of the camera 1080. The controller 1110 may compare the separation of the lift forks 1076 to the separation of the fork pockets 1096 and determine one or more actuators of the actuator system 1078 that may be operated to increase or decrease the separation of the lift forks 1076 to match (or be withing a predetermined threshold of) the separation of the fork pockets 1096. For example, the fork separation actuator 1086 may be used to adjust the separation of the lift forks 1076 responsive to the separation between the lift forks 1076 not matching a separation of the fork pockets 1096.

The desired operation may include matching an alignment of the lift fork 1076 to an alignment of the fork pocket 1096. The controller 1110 may determine a location of the edges of the fork pocket 1096 based on the image data of the camera 1080. The controller 1110 may determine a location of the edges of the lift fork 1076 based on sensor data of the elevation sensor 1126, fork separation sensor 1124, distance sensor 1128, the position of the fork separation actuator 1086, and/or known characteristics of the lift fork 1076 (e.g., width, length, thickness). The controller 1110 may compare the location of the edges of the lift fork 1076 to the location of the edges of the fork pocket 1096 and determine one or more actuators of the actuator system 1078 that may be operated to adjust the alignment of the lift fork 1076 such that the distance between the lift fork 1076 and the fork pocket 1096 is below a predetermined threshold, and the lift fork 1076 is positioned such that the edges of the lift fork 1076 fall within the edges of the fork pocket 1096. For example, the primary driver 1032, the steering actuator 1088, the lift actuator 1070, and/or the extension actuator 1072 may be used to adjust the alignment of the lift fork 1076.

The alignment operation may include operating actuators of the lift assembly 1050 to adjust the distance between the lift fork 1076 and the fork pocket 1096, and/or position the lift fork 1076 edges within the fork pocket 1096 edges. For example, the lift actuator 1070 may be operated to adjust the angle between the base boom 1060 and the longitudinal centerline L, thereby adjusting the distance between the lift fork 1076 and the fork pocket 1096. As another example, in cases where the base boom 1060 is not perpendicular to the longitudinal centerline L, the extension actuator 1072 may be operated to adjust the length of the lift assembly 1050, thereby adjusting the distance between the lift fork 1076 and the fork pocket 1096.

The alignment operation may include operating actuators of the chassis to align the lift fork 1076 and the fork pocket 1096. This may occur responsive to the range of motion of the lift assembly 1050 not satisfying the threshold conditions for alignment. For example, the steering actuator 1088 may be operated to adjust a position of the tractive elements 1030 coupled to the chassis. By adjusting the position of the tractive elements 1030, the operator may be able to reposition the chassis such that alignment of the lift fork 1076 and the fork pocket 1096 is achieved. As another example, the primary driver 1032 may be operated to adjust the position of the chassis. By adjusting the position of the chassis, the operator may be able to facilitate alignment of the lift fork 1076 and fork pocket 1096.

The alignment operation of the lift fork 1076 may include adjusting the elevation of the lift fork 1076, such that the elevation of the lift fork 1076 no longer matches the elevation of the fork pocket 1096. For example, the lift actuator 1070 may be used to decrease the distance between the lift fork 1076 and the fork pocket 1096. Due to the configuration of the lift actuator 1070, the elevation of the lift fork 1076 may be adjusted simultaneously to adjusting the distance between the lift fork 1076 and the fork pocket 1096. For example, to mitigate undesired impacts caused by actuator movements, actuators of the actuator system 1078 may be operated concurrently to maintain the elevation of the lift fork 1076 while adjusting the alignment. For example, the lift actuator 1070 may be operated to adjust the angle between the base boom 1060 and the longitudinal centerline L, thereby adjusting the distance between the lift fork 1076 and the fork pocket 1096. Simultaneously, the extension actuator 1072 may be operated to adjust the length of the lift assembly 1050, thereby maintaining the elevation of the lift fork 1076 while adjusting the distance between the lift fork 1076 and the fork pocket 1096.

Upon aligning the lift fork 1076 to the fork pocket 1096, the controller 1110 may receive sensor data from the level sensor 1122 indicating an angle of the lift fork 1076 relative to the longitudinal centerline L. The controller 1110 may receive image data from the camera 1080 indicating an angle of the storage container 1090 relative to the longitudinal centerline L. The controller 1110 may compare the angle of the lift fork 1076 and the angle of the storage container to determine a desired level of the lift fork 1076 to achieve proper insertion of the lift fork 1076 into the fork pocket 1096. For example, after alignment, the lift fork 1076 may be in a position that allows for partial insertion into the fork pocket 1096, but due to the angle of the storage container 1090, the lift fork 1076 may not be positioned to be inserted through the entire fork pocket 1096. By adjusting the level of the lift fork 1076, the lift fork 1076 may facilitate full insertion into the fork pocket 1096.

Upon determining the desired level of the lift fork 1076, the controller 1110 may execute the desired operation of the actuators to align the lift fork 1076 and the fork pocket 1096. In some embodiments, the desired operation includes transmitting an instruction to the actuator system 1078 to automatically operate one or more actuators to align the lift fork 1076 and the fork pocket 1096. In some embodiments, the desired operation includes transmitting an instruction to the user interface 1120 to display a message indicating an operating procedure, based on the determined actuator operations, for the user to execute. The operating procedure may include a plurality of steps for movement of the lift fork 1076 and/or the telehandler 1010 such that the lift fork 1076 can be aligned and/or inserted into the fork pocket 1096. The user interface 1120 may display a step-by-step (e.g., iterative) operating procedure for aligning the lift fork 1076 to the fork pocket 1096. In some embodiments, the operating procedure includes automatically operating the steering actuator 1088 and transmitting an instruction to the user interface 1120 to display a message indicating that the user should operate the primary driver to move the chassis. In some embodiments, the operating procedure includes inserting the lift fork 1076 into the fork pocket 1096. In some embodiments, the operating procedure includes an automatic alignment process, and insertion responsive to interaction with a selectable element of the user interface 1120.

In some embodiments, the operating procedure can be executed automatically (e.g., by the processors 1112). For example, the operating procedure may include operating the primary driver 1032 to move the chassis. As another example, the operating procedure may include operating the lift actuator 1070 to adjust an elevation of the lift assembly 1050. As another example, the operating procedure may include operating the fork elevation actuator 1084 to adjust an elevation of the lift fork 1076 relative to a base of the lift assembly 1050. As another example, the operating procedure may include operating the fork separation actuator 1086 to adjust a distance between the first lift fork 1076 and a second lift fork 1076. As another example, the operating procedure may include operating the level actuator 1074 to adjust an angle of the lift fork 1076 relative to the base of the lift assembly 1050. As another example, the operating procedure may include operating an actuator of the actuator system 1078 or the primary driver 1032 to adjust the position of the lift fork 1076 such that an edge of the lift fork 1076 is within a threshold distance of an edge of the fork pocket 1096. As another example, the operating procedure may include operating one or more actuators of the actuator system 1078 or the primary driver 1032 such that a front portion of the lift fork 1076 is within a threshold distance of the fork pocket 1096.

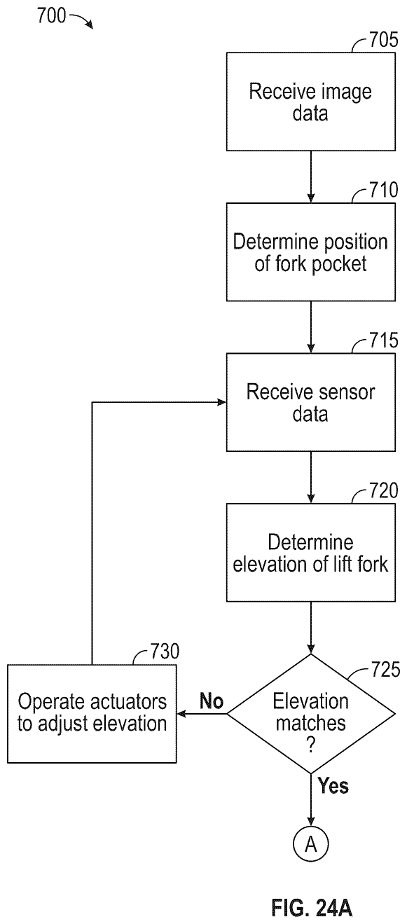

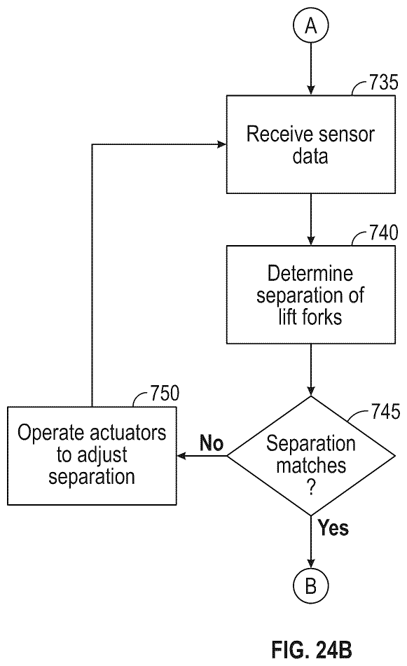

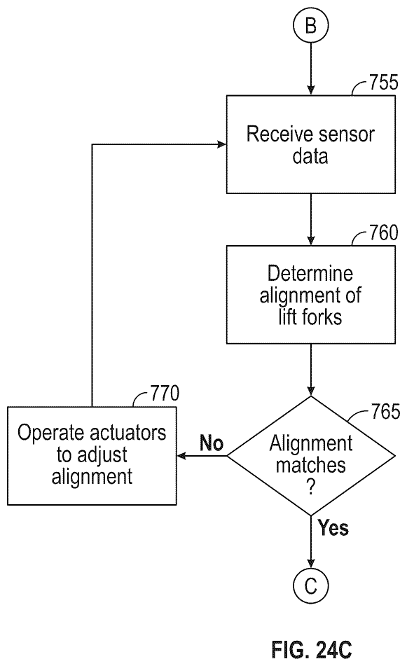

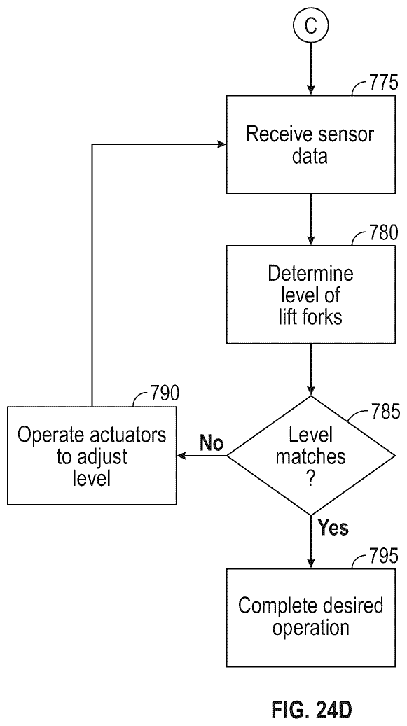

Referring generally to FIG. 24A-24D, depicted is a flow diagram for a multi-tiered automated process 700 for executing fork alignment using image recognition, according to an exemplary embodiment. The steps described herein may be executed in the order provided, or in any other order, and separately or in combination with other steps simultaneously. In other embodiments, steps may be omitted from the process 700, and/or steps may be added to the process 700. Referring to FIG. 7A, depicted is partial flow diagram of the process 700, relating to receiving image data and sensor data, and matching an elevation of the lift fork 1076 to an elevation of the fork pocket 1096. At step 705, image data is received by the controller 1110 from the camera 1080. The image data may be pre-recorded video and/or image data, or the image data may be live stream video.

At step 710, the controller 1110 may determine a position of the fork pocket 1096 based on the image data. The controller 1110 may process the image data to determine a position of the fork pocket 1096, an elevation of the fork pocket 1096, a separation of the fork pocket 1096 and a second fork pocket 1096, a position indicating the edges of the fork pocket 1096, and/or an angle between the storage container 1090 and the longitudinal centerline L.

At step 715, the controller 1110 may receive sensor data from the sensor system 1130. The sensor data may include a plurality of readings from the elevation sensor 1126, the level sensor 1122, the fork separation sensor 1124, and/or the distance sensor 1128. At step 720, the controller 1110 may process the sensor data to determine an elevation of the lift fork 1076. The elevation of the lift fork 1076 may be determined based on sensor data from the elevation sensor 1126.

At step 725, the controller 1110 may determine whether the elevation of the lift fork 1076 matches the elevation of the fork pocket 1096. For example, the elevation of the lift fork 1076 may be within a threshold elevation difference from the fork pocket 1096. At step 730, if the elevation of the lift fork 1076 does not match the elevation of the fork pocket 1096, the controller 1110 may operate one or more actuators of the actuator system 1078 to adjust the elevation of the lift fork 1076. For example, the controller 1110 may operate the lift actuator 1070 to adjust the elevation of the lift fork 1076. The controller 1110 may then retrieve sensor data from the sensor system 1130, determine the elevation of the lift fork 1076, determine whether the elevation matches, and perform additional actuator adjustments (e.g, as described regarding steps 715-730), until the elevation of the lift fork 1076 matches the elevation of the fork pocket 1096.

Referring to FIG. 24B, depicted is partial flow diagram of the process 700, relating to receiving sensor data, and matching a separation of the lift fork 1076 and a second lift fork 1076 to a separation of the fork pocket 1096 and a second fork pocket 1096. At step 735, once the elevation of the lift fork 1076 matches the elevation of the fork pocket 1096, the controller 1110 receives sensor data from the sensor system. For example, the controller may receive sensor data from the fork separation sensor 1124. At step 740, the controller 1110 may determine a separation between the lift fork 1076 and the second lift fork 1076. The separation may be based on one or more readings by the fork separation sensor of a horizontal distance between the inside edges of the lift forks 1076.

At step 745, the controller 1110 may compare the separation of the lift forks 1076 to the separation of the fork pockets 1096. The comparison may include a determination that the difference between the separation of the fork pockets 1096 and the separation of the lift forks 1076 is below a threshold separation difference. At step 750, if the separation does not match (or difference is not below the threshold separation distance), the controller 1110 may operate the one or more actuators of the actuator system 1078 to adjust the separation of the lift forks 1076. For example, the fork separation actuator 1086 may increase/decrease the separation of the lift forks 1076. The controller 1110 may then retrieve sensor data from the sensor system 1130, determine separation of lift forks 1076, and perform additional actuator adjustments (e.g., as described regarding steps 735-750), until the separation of the lift forks 1076 matches the separation of the fork pocket 1096.

Referring to FIG. 24C, depicted is a partial flow diagram for the multi-tiered process 700, relating to aligning the lift fork 1076 to the fork pocket 1096. At step 755, the controller 1110 may receive sensor data from the distance sensor 1128 and/or the elevation sensor 1126, or inferred from the positions of one or more actuators of the telehandler 1010. At step 760, the controller may determine the alignment of the lift fork 1076. This determination may be based on the sensor data, as well as known characteristics of the lift fork 1076. The alignment of the lift fork 1076 may be related to positions (e.g., locations) of the edges of the lift fork 1076.

At step 765, the controller 1110 may determine whether the alignment of the lift fork 1076 matches the alignment of the fork pocket 1096. The determination may be based on the edges of the lift fork 1076 being within the edges of the fork pocket 1096, and the lift fork 1076 being below a predetermined distance away from the fork pocket 1096. At step 770, if the alignment does not match, the controller 1110 may operate one or more actuators of the actuator system 1078 to adjust the alignment of the lift fork 1076. For example, the lift actuator 1070 may be operated to position the lift fork 1076 a smaller distance away from the fork pocket 1096. The controller 1110 may then retrieve sensor data from the sensor system 1130, determine the alignment of the lift forks 1076, and perform additional actuator adjustments (e.g., as described regarding steps 755-770), until the alignment of the lift fork 1076 matches the alignment of the fork pocket 1096.

Referring to FIG. 24D, depicted is a partial flow diagram for the multi-tiered process 700, relating to adjusting the level of the lift fork 1076 to a desired angle. At step 775, the controller 1110 may receive sensor data from the level sensor 1122, indicating an angle between the lift fork 1076 and the longitudinal centerline L. At step 780, the controller 1110 may process the sensor data to determine the level of the lift fork 1076. For example, the controller 1110 may determine an angle of the lift fork 1076 relative to the longitudinal centerline L. At step 785, the controller 1110 may determine whether the level of the lift fork 1076 matches the level of the fork pocket 1096. The level may match when the angle between the lift fork 1076 and the longitudinal centerline L is equal to (or within a predetermined threshold difference of) the angle between the storage container 1090 and the longitudinal centerline L.

At step 790, if the level of the lift fork 1076 does not match the level of the fork pocket 1096, the controller 1110 may operate one or more actuators of the actuator system 1078 to adjust the level of the lift fork 1076. For example, the controller 1110 may operate the level actuator 1074 to adjust the level of the lift fork 1076. The controller 1110 may then retrieve sensor data from the sensor system 1130, determine the level of the lift fork 1076, determine whether the level matches the level of the fork pocket 1096, and perform additional actuator adjustments (e.g., as described regarding steps 775-790), until the level of the lift fork 1076 matches the level of the fork pocket 1096. At step 795, once the level of the lift fork 1076 matches the level of the fork pocket 1096, the controller 1110 may complete the desired operation. The desired operation may be based on a user input to the user interface 1120, such as a command to align the lift fork 1076 to the fork pocket 1096. In some embodiments, the desired operation includes the desired operations of communication system 600.

### User Interfaces

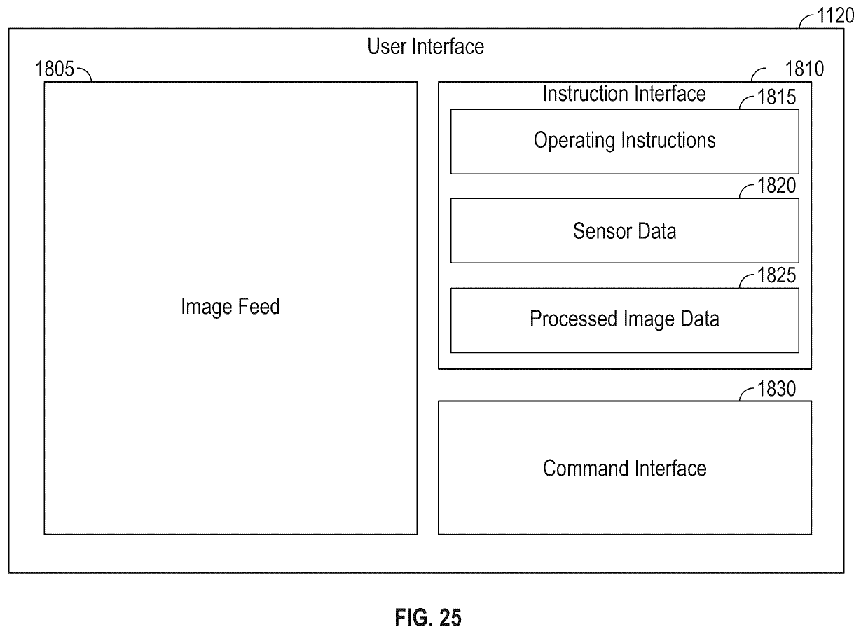

Referring to FIG. 25, depicted is the user interface 1120 of the telehandler 1010, according to an exemplary embodiment. In some embodiments, the user interface 1120 is disposed within the cabin 1020 of the telehandler 1010, such that a user may access the user interface 1120 while operating the telehandler 1010. In some embodiments, the user interface 1120 may be a user device configured to be operated remotely of the operation of the telehandler 1010. The user interface 1120 may be a graphical user interface (GUI), including a display (e.g., touch screen, monitor) and an interface (e.g., selectable elements, buttons, keypad, etc.) configured to receive user inputs. The user interface 1120 may be configured to transmit/receive executable instruction to/from the controller 1110.

The user interface 1120 may include an image feed 1805 transmitted by the camera 1080. For example, the controller 1110 may transmit the image data from the camera to the user interface 1120, and the user interface 1120 may convert the image data into the image feed 1805. In some embodiments, the image feed 1805 is a live stream (e.g., real-time recording) of the camera 1080. In some embodiments, the image feed 1805 may be pre-recorded photo and/or video. The image feed 1805 may be altered or otherwise manipulated by the controller 1110. For example, the image feed 1805 may include a live stream of the camera 1080, including elements (e.g., augmented reality features) added by the controller 1110 to emphasize the fork pocket 1096.

The controller 1110 may manipulate or otherwise modify the image feed 1805 to include an overlay indicating the identified fork pockets 1096 and/or lift forks 1076. For example, the overlay may include a computer-generated outline of the fork pockets 1096 and/or lift forks 1076 to provide a visual indication that the controller 1110 has properly identified the fork pockets 1096 and/or lift forks 1076. The overlay may be based on the real-time alignment of the lift forks 1076 and the fork pockets 1096. For example, the computer-generated outline of the fork pockets 1096 and/or lift forks 1076 may be a first color when the lift forks 1076 and fork pockets 1096 are not aligned, and a second color when the lift forks 1076 and fork pockets 1096 are aligned. In the event that the controller 1110 has not properly identified the lift forks 1076 and/or the fork pockets 1096, the user may interact with the user interface 1120 to initiate a recalibration process of the sensor system 1130 and/or the camera 1080. The recalibration process may cause the controller 1110 to reprocess and/or recapture the image data and the sensor data to determine the position of the lift forks 1076 and the fork pockets 1096.

In some embodiments, the telehandler 1010 includes a plurality of cameras 1080 disposed along the lift fork assembly 1052 and/or the lift assembly 1050. The image feed 1805 may include multiple image perspectives. For example, a first camera 1080 may be in view of the storage container 1090, and a second camera 1080 may be in view of the lift fork 1076. The image feed 1805 may include perspective from both cameras 1080, thereby allowing the user to view both the storage container 1090 and the lift fork 1076. Multiple image perspectives may be beneficial during manual operation of the telehandler 1010.

The user interface 1120 may include an instruction interface 1810 configured to display information relating to the telehandler 1010. The instruction interface 1810 may display operating instructions 1815, sensor data 1820, and/or processed image data 1825. The operating instruction 1815 may include an operating procedure for the telehandler 1010 to facilitate the alignment and/or insertion of the lift fork 1076 into the fork pocket 1096. The operating procedure may include a plurality of steps for movement of the lift fork and/or the telehandler 1010 such that the lift fork 1076 can be aligned with and/or inserted into the fork pocket 1096. For example, the operating procedure may be a procedure for automatic operation of the telehandler 1010. For example, the operating procedure may include instructions for operating one or more actuators of the actuator system 1078 to align the lift fork 1076 and the fork pocket 1096. As another example, if the telehandler 1010 is configured to automatically align the lift fork 1076 and the fork pocket 1096, the operating instructions may include instructions for operating the primary driver 1032 to insert the lift fork 1076 into the fork pocket 1096. In some embodiments, the instruction interface 1810 displays a step-by-step process for automated fork alignment. For example, the instruction interface 1810 may display actuator commands determined by process 700.

The sensor data 1820 may include readings from the sensors. In some embodiments, the user interface 1120 receives sensor data 1820 from the controller 1110 in real-time and display the sensor data 1820 on the instruction interface 1810. For example, the sensor data 1820 may include an elevation of the lift fork 1076, a separation of the lift forks 1076, a level (e.g., angle) of the lift forks 1076, and/or a distance between the lift fork 1076 and the fork pocket 1096. Displaying the sensor data 1820 may beneficial during manual operation of the telehandler 1010. The processed image data 1825 may include information based on the controller 1110 processing the image data. In some embodiments, the user interface 1120 receives information from the controller 1110 regarding the image data and display the processed image data 1825 on the instruction interface 1810. For example, the processed image data may include an elevation of the fork pocket 1096, a separation of the fork pockets 1096, a level (e.g., angle of the storage container), and/or a distance between the fork pocket 1096 and the lift fork 1076.

The user interface 1120 may include a command interface 1830 configured to receive user inputs and transmit the user inputs to the controller 1110. The command interface 1830 may include selectable elements (e.g., buttons, keypad, touch screen) configured to be interacted with by the user. For example, the command interface 1830 may include a touch screen configured to transmit an instruction to the controller 1110 to control an operation of the telehandler 1010. The instructions may be controlling instructions for actuators, drivers, sensors, and/or cameras of the telehandler 1010. The instructions may be controlling instructions for elements of the user interface 1120. For example, the user may interact with the command interface 1830 to control elements of the image feed 1805 such as pausing or resuming the image feed 1805. The command interface 1830 may be used to acknowledge operating instructions 1815. For example, the command interface 1830 may be used to acknowledge or otherwise validate automated actuator commands determined by process 700.

### Additional Embodiments

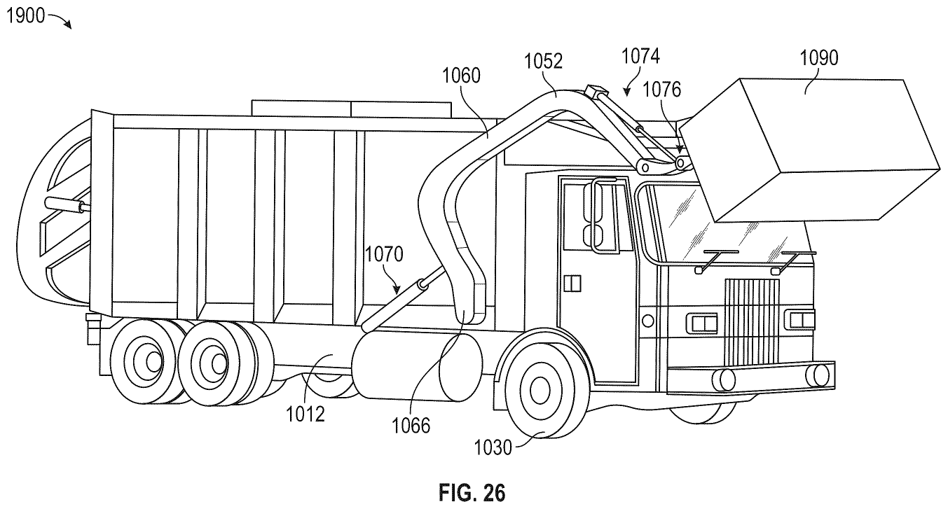

Referring to FIG. 26, depicted is a front-loading refuse vehicle 1900, according to an illustrative embodiment. In some embodiments, front-loading refuse vehicle 1900 is the work machine. In some embodiments, the front-loading refuse vehicle 1900 includes one or more components of the telehandler 1010. In some embodiments, the front-loading refuse vehicle 1900 includes the communication system 900 and/or can execute the multi-tiered alignment process 700.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X; Y; Z; X and Y; X and Z; Y and Z; or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device) may include one or more devices (e.g., RAM, ROM, Flash memory, hard disk storage) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicle 10 and the systems and components thereof as shown in the various exemplary embodiments is illustrative only. Additionally, any element disclosed in one embodiment may be incorporated or utilized with any other embodiment disclosed herein. Although only one example of an element from one embodiment that can be incorporated or utilized in another embodiment has been described above, it should be appreciated that other elements of the various embodiments may be incorporated or utilized with any of the other embodiments disclosed herein.

What is claimed is:

1. A system for monitoring a vehicle, the system comprising:
a first sensor configured to detect at least one parameter of a vehicle; and
at least one controller communicably coupled to the first sensor, wherein the controller comprises a processor and a memory storing code, the code including instructions that when executed by the processor cause the processor to:
receive, from the first sensor, a signal indicating the at least one parameter;
determine a state associated with the vehicle based on the at least one parameter;
determine, based on the state and a target state, if the vehicle is in a target configuration; and
perform, based on the vehicle being in the target configuration, an automated control action, wherein the automated control action comprises providing a first alert indicating that the vehicle is in the target configuration.

2. The system of claim 1, wherein the code further includes instructions that when executed by the processor cause the processor to:
receive an input indicating a type of vehicle; and
determine, based on the type, a set of parameters associated with the target configuration, wherein the at least one parameter includes the set of parameters.

3. The system of claim 2, wherein determining the set of parameters comprises receiving, from a database, the set of parameters based on the input.

4. The system of claim 1, wherein the code further includes instructions that when executed by the processor cause the processor to perform, based on the vehicle not being in the target configuration, a second automated control action, the second automated control action comprising a second alert indicating the vehicle is not in the target configuration.

5. The system of claim 1, wherein the at least one parameter includes at least one of a tire position, an implement position, a lighting state, or secure attachment to a shipping structure.

6. The system of claim 5, wherein the at least one parameter includes the tire position, and wherein the code further includes instructions that when executed by the processor cause the processor to:
receive a tire position associated with the target configuration;
receive, from the first sensor, a position of one or more tires of the vehicle;
determine if each of the one or more tires are in the tire position associated with the target configuration; and
perform a second automated control action based on the one or more tires not being in the tire position associated with the target configuration, the second automated control action comprising adjusting the position of the one or more tires.

7. The system of claim 5, wherein the at least one parameter includes the lighting state, and wherein the code further includes instructions that when executed by the processor cause the processor to:
receive a lighting state associated with the target configuration, wherein the lighting state associated with the target configuration is an off state;
receive a state of a lighting system of the vehicle;
determine if the lighting system is in the off state; and
perform a second automated control action based on the lighting system not being in the off state, the second automated control action comprising operating the lighting system to transition to the off state.

8. The system of claim 5, wherein the at least one parameter include the secure attachment to the shipping structure, and wherein the code further includes instructions that when executed by the processor cause the processor to:
receive a securing constraint position associated with the target configuration;
receive, from the first sensor, a position of one or more securing constraints;
determine if each of the one or more securing constraints are in the securing constraint position associated with the target configuration; and
perform a second automated control action based on the one or more securing constraints not being in the position associated with the target configuration, the second automated control action comprising a second alert indicating the one or more securing constraints are not in the securing constraint position associated with the target configuration.

9. The system of claim 5, wherein the at least one parameter includes the implement position, and wherein the code further includes instructions that when executed by the processor cause the processor to:
receive an implement position associated with the target configuration;
receive, from the first sensor, a position of an implement of the vehicle;
determine if the implement is in the implement position associated with the target configuration; and
perform a second automated control action based on the implement not being in the implement position associated with the target configuration, the second automated control action comprising adjusting the position of the implement.

10. The system of claim 1, wherein the first sensor is configured to be integrated onto the vehicle or separate from the vehicle.

11. The system of claim 1, wherein the automated control action further comprises controlling the vehicle to adjust the at least one parameter until the state matches the target state.

12. The system of claim 1, wherein the code further includes instructions that when executed by the processor cause the processor to:
receive an input indicating a type of shipping structure the vehicle is to be transported by; and
determine, based on the type, a set of parameters associated with the target configuration, wherein the at least one parameter includes the set of parameters.

13. A method for monitoring a vehicle, the method comprising:
receiving, from a sensor, a signal indicating at least one parameter of a vehicle;
determining a state associated with the vehicle based on the at least one parameter;
determining, based on the state and a target state, if the vehicle is in a target configuration; and
providing a first alert indicating that the vehicle is in the target configuration.

14. The method of claim 13, further comprising:
receiving an input indicating a type of vehicle; and
determining, based on the type, a set of parameters associated with the target configuration, wherein the at least one parameter includes the set of parameters.

15. The method of claim 14 wherein determining the set of parameters comprises receiving, from a database, the set of parameters based on the input.

16. The method of claim 14, further comprising:
perform, based on the vehicle not being in the target configuration, a second automated control action, the second automated control action comprising a second alert indicating the vehicle is not in the target configuration.

17. A system comprising:
a vehicle having one or more components;
one or more sensors at least one of the one or more sensors coupled to or separate from the vehicle and configured to detect current parameters of the one or more components of the vehicle; and
a controller communicably coupled to the one or more sensors wherein the controller comprises a processor and a memory storing code, the code including instructions that when executed by the processor cause the processor to:
receive a set of parameters associated with a target state for the vehicle, the set of parameters being associated with the one or more components of the vehicle;
receive, from the one or more sensors, data indicative of the current parameters of the one or more components of the vehicle;
compare the current parameters of the one or more components of the vehicle to the set of parameters associated with the target state for the vehicle; and
operate at least one of the one or more components of the vehicle until the current parameters of the one or more components of the vehicle match the set of parameters for the one or more components of the vehicle.

18. The system of claim 17, wherein the set of parameters associated with the target state for the vehicle comprise a target position for a first component of the one or more components of the vehicle, and wherein the code includes instructions that when executed by the processor cause the processor to adjust a position of the component until the position of the first component matches the target position for the first component.

19. The system of claim 17, wherein the code further includes instructions that when executed by the processor cause the processor to generate an approval signal indicating that the vehicle is in the target state in response to the current parameters of the one or more components of the vehicle matching the set of parameters for the one or more components of the vehicle.

20. The system of claim 17, wherein the code further includes instructions that when executed by the processor cause the processor to generate a rejection signal indicating that the vehicle is not in the target state in response to the current parameters of the one or more components of the vehicle failing to match the set of parameters for the one or more components of the vehicle.
